(19) United States
(12) Patent Application Publication
(10) Pub. No.: US 2023/0167233 A1
(43) Pub. Date: Jun. 1, 2023

(54) UPCYCLING OF POLYSTYRENE REINFORCED 3D PRINTABLE PHOTOPOLYMER NANOCOMPOSITES AND RING OPENING COPOLYMERIZATION

(71) Applicant: Ohio University, Athens, OH (US)

(72) Inventor: Andrew Weems, Athens, OH (US)

(21) Appl. No.: 17/997,051

(22) PCT Filed: Apr. 29, 2021
(86) PCT No.: PCT/US2021/029913

§ 371 Date: Oct. 25, 2022

Related U.S. Application Data
(60) Provisional application No. 63/017,288, filed on Apr. 29, 2020.

(51) Int. Cl. C08G 63/18; B33Y 70/00; B33Y 80/00; C08K 5/37; C08K 5/53; C08L 25/06

(52) U.S. Cl. CPC C08G 63/18; B33Y 70/00; B33Y 80/00; C08K 5/37; C08K 5/53; C08L 25/06

(57) ABSTRACT

A 3D printable resin is provided. The 3D printable resin includes a polystyrene and at least one of a solubilizing crosslinker or a solubilizing polymer. Alternatively, a ring-opened polyester copolymer is provided. The ring-opened polyester copolymer is a product of a reaction between a cyclohexene anhydride and a glycidol allyl ether. In addition, A polyester resin is provided. The polyester resin includes a product of a reaction between a cyclohexene anhydride and a glycidol allyl ether, a 4-arm thiol, and a photoinitiator.

### CROSS-REFERENCE TO RELATED APPLICATIONS

This application is a U.S. national phase (under 35 U.S.C. § 371) of International Patent Application Serial No. PCT/US2021/029913 entitled “Upcycling of Polystyrene-Reinforced 3D Printable Photopolymer Nanocomposites and Ring Opening Copolymerization”, filed Apr. 29, 2021, the disclosure of which is incorporated by reference herein in its entirety. This application claims the benefit of the filing date of, and priority to, U.S. Pat. Application Serial No. 63/017,288, entitled “Recycling Method of Commodity Plastics to Produce Composite 3D Printing Resins,” filed Apr. 29, 2020, the disclosure of which is incorporated by reference herein in its entirety.

### FIELD OF THE INVENTION

Aspects of the present invention generally relate to 3D printable resins, and ring-opened polyester copolymers.

### BACKGROUND

This section is intended to introduce the reader to various aspects of art that may be related to various aspects of the present invention, which are described and/or claimed below. This discussion is believed to be helpful in providing the reader with background information to facilitate a better understanding of various aspects of the present invention. Accordingly, it should be understood that these statements are to be read in this light, and not as admissions of prior art.

Commodity plastics have become a staple of everyday life. However, there are many issues with the current model of plastic disposal with regards to the environment. The linear economy model, while useful for establishing manufacturing and global infrastructure, is not sustainable and is causing enormous impact on wildlife in communities, in the wild, and particularly in aquatic environments. There is a great need for a circular economy in commodity plastics, and the idea of upcycling has begun to emerge as one way to ensuring that used plastics could find alternative uses without requiring their disposal as pollution.

Polystyrene (PS), one of the widest used commodity plastics, is known for the range of appearances that it can be processed into, including foam (Styrofoam). The stability of PS has led to its use in numerous applications ranging from tissue culture plates to construction materials, but this same biostability has also made it difficult to dispose of PS. Pyrolysis of PS typically requires temperatures up to 430° C. and increased pressures, making it difficult to reclaim styrene monomer for use in alternative applications. PS takes on very little water, making hydrolysis a very slow process, and most forms are resistant to photo-oxidation, further rendering them stable in most environments.

The solubilization of PS has been widely studied, including the use of typical solvents (halogenated and non-halogenated), hydrocarbon-materials, and even naturally occurring compounds such as limonone and other terpenes. Some of these studies went so far as to explore the recycling of PS into limonene networks to make nanocomposite materials; however, this was limited by the thermally-driven reaction which would prevent widespread use. Recently, exploration of 3D printing of terpenes demonstrated the utility of several natural products that could be used for producing photopolymer resins, possibly opening avenues into upcycling of PS into higher value products such as 3D printing resins.

Furthermore, 3D printing (3DP) is rapidly becoming a viable manufacturing method in its own right; however, 3DP has been limited in many fields by the lack of suitable materials. Most notably this is found in biomaterials, particularly with photopolymers that utilize acrylates that may be toxic. There is a need for the development of new photopolymer formulations that are compatible with the rapid manufacturing needs within the additive manufacturing community while also being able to serve the biomedical community’s needs. Here we present our development of 3D printable photopolymer resins that leverage ring opening copolymerization (ROCOP) in the production of 4D materials.

For polymeric biomaterials, ring opening polymerizations (ROP) have offered a number of advantages, including tunable dispersity, molecular weight, and architecture in a broad library of possible materials. An important subset of ROP is ring opening copolymerization, most commonly represented by the copolymerization of a cyclic anhydride and an epoxide monomer to produce a copolyester. Such materials have been presented as possessing interesting elastomeric behaviors with select formations, as well as shape memory behaviors under certain conditions. The Williams groups recently presented an example of orthogonal functionalization of ROCOP-produced polyesters, leveraging thiol-ene reactions to functionalize the linear polymers with different pendant groups. With regards to 3D printing, this is an important feature to consider, as photopolymerizations such as thiol-ene reactions are most likely to produce mechanically integrated components relative to other 3DP methods. Such a concept has been well demonstrated by the Becker group using maleic anhydride, propylene oxide, and various diols to produce different oligomers and polymers for photopolymerization-type 3DP such as digital light processing (DLP).

Within the field of 3DP, an important concept has recently emerged that focuses on the long-term behavior of the materials. This temporal consideration has led to the design of 4D materials, which include designed solvent swelling, shape memory behavior, and even tuned degradation profiles in controlled manners. While the term “4D material” is gaining in popularity, there are still only a few formulations of these materials which possess robust mechanical properties as well as advanced functionalities which render them appealing for 3DP.

### SUMMARY

Certain exemplary aspects of the invention are set forth below. It should be understood that these aspects are presented merely to provide the reader with a brief summary of certain forms the invention might take and that these aspects are not intended to limit the scope of the invention. Indeed, the invention may encompass a variety of aspects that may not be explicitly set forth below.

Various aspects of the present invention provide a 3D printable resin, a ring-opened polyester copolymer, and a 3D printable resin using the ring-opened copolymer. The embodiments described below are not intended to limit the scope of the invention to the embodiments explicitly described, but are included to serve as examples of the invention disclosed herein.

In an embodiment, a 3D printable resin is provided. The 3D printable resin includes a polystyrene and at least one of a solubilizing crosslinker, a solubilizing polymer, a natural terpene, a natural terpenoid, or a natural polymer..

In another embodiment, a ring-opened polyester copolymer is provided. The ring-opened polyester copolymer is a product of a reaction between a cyclic anhydride and an epoxide.

In another embodiment, a polyester resin is provided. The polyester resin includes a product of a reaction between a cyclic anhydride and an epoxide,, a multi-arm thiol, and a photoinitiator.

### BRIEF DESCRIPTION OF THE FIGURES

The accompanying drawings, which are incorporated in and constitute a part of this specification, illustrate embodiments of the invention and, together with the general description of the invention given above and the detailed description of the embodiments given below, serve to explain the principles of the present invention.

FIG. 1A is a photograph of a resin solubilizing polystyrene;

FIG. 1B is a photograph of a resin solubilizing polystyrene;

FIG. 1C is a photograph of a resin solubilizing polystyrene;

FIG. 2A is a photograph of a recycled resin-polystyrene nanocomposite;

FIG. 2B is a photograph of a recycled resin-polystyrene nanocomposite;

FIG. 2C is a photograph of a recycled resin-polystyrene nanocomposite;

FIG. 3 is a spectroscopic analysis of myrcene, polymyrcene, and a recycled polymyrcene;

FIG. 3A is a photograph of a polystyrene resin’s degradation over time;

FIG. 3B is a photograph of a polystyrene resin’s degradation over time;

FIG. 3C is a photograph of a polystyrene resin’s degradation over time;

FIG. 4A is a graph showing a degradation of mass vs. time of polystyrene being solubilized in a recycle solution;

FIG. 4B is a graph showing a rate of change in degradation of mass vs. time of polystyrene being solubilized in a recycle solution;

FIG. 5 is a graph showing a storage modulus vs. time of various resin solutions compared against each other;

FIG. 6A is a photograph of a resin-PS shape memory apparatus;

FIG. 6B is a photograph of a resin-PS shape memory apparatus;

FIG. 6C is a photograph of a resin-PS shape memory apparatus;

FIG. 6D is a photograph of a resin-PS shape memory apparatus;

FIG. 6E is a photograph of a resin-PS shape memory apparatus;

FIG. 6F is a photograph of a resin-PS shape memory apparatus;

FIG. 7 is a graph showing a stress vs. strain of a linalool-PS resin and a linalool allyl ether-PS resin;

FIG. 8 is a graph showing a storage modulus vs. time of a linalool-PS resin and a linalool allyl ether-PS resin;

FIG. 9 is a graph showing stress vs. strain results for a limonene-PS network at 120° C., a limonene-PS network at 80° C., and a polyester (limonene co TMPAC);

FIG. 10 is a graph showing stress vs. strain results for a polymyrcene resin before recycle, a polymyrcene resin after recycle, and a polymyrcene hexadecanethiol resin;

FIG. 11 is a digital light processing-type 3D printing schematic to produce porous cubes;

FIG. 12 is a graph showing the viscosity behavior of a polyester-derived resin;

FIG. 13 is a graph showing various ultraviolet-visible light spectra for selected photoinitiators and the polyester;

FIG. 14 is a graph showing conversion of the cyclohexene alkene compared with the allyl alkene as measure by ¹H NMR for (alkene:thiol:photoinitiator) samples in CDCl₃.

FIG. 15A is a representative image of the printed porous structures, displaying a reassembled structure imaged using micro CT;

FIG. 15B is a representative image of the printed porous structures displaying an optical microscopy of a similar printed structure;

FIG. 16A is a graph representing uniaxial tensile curves to failure for modified ASTM Type IV dogbones tested at 5 mm × min⁻¹ at 25° C. under ambient atmosphere;

FIG. 16B is a graph showing thermal analysis of the complex moduli of the polyester film as determined by shear rates across three orders of magnitude;

FIG. 16C is a graph showing cyclic tensile testing of polyester copolymer films tested at 5 mm × min⁻¹ at 25° C. under ambient atmosphere for 100 cycles;

FIG. 16D is a graph showing cyclic tensile testing of polyester copolymer films tested at 5 mm × min⁻¹ at 65° C. under ambient atmosphere for 100 cycles;

FIG. 16E is a graph showing energy absorbed, returned, and lost for polyester copolymer films as a function of cycle;

FIG. 16F is a graph showing the energy lost/elastic moduli for polyester copolymer films as a function of temperature for samples tested cyclic tensile testing of polyester copolymer films tested at 5 mm × min⁻¹ under ambient atmosphere at cycle 2;

FIG. 17A is a representative quantified shape recovery of polyester copolymer films tested using thermal sweeps and uniaxial cyclic testing at cycle 2;

FIG. 17B is a graph showing corresponding representative strain recovery sweeps varying the recovery rate from 0.01 mm x min⁻¹ to 10 mm x min⁻¹ at 50° C., ambient atmosphere;

FIG. 17C is an image of an original printed porous structure;

FIG. 17D is an image of a deformed structure;

FIG. 17E is a topographical image of a strut reorientation during a strain fixation;

FIG. 17F is an image showing shape memory behavior of a printed porous structure 5 seconds after fixation;

FIG. 17G is an image showing shape memory behavior of a printed porous structure 10 seconds after fixation;

FIG. 17H is an image showing shape memory behavior of a printed porous structure 20 seconds after fixation;

FIG. 18A is a ¹H NMR chart of polyester cyclohexene and allyl ether collected on a 500 MHz Bruker spectrometer at 20° C. in DMSO_{d6};

FIG. 18B is a 13C NMR spectra of polyester cyclohexene and allyl ether, collected on a 500 MHz Bruker spectrometer at 20° C. in DMSO_{d6};

FIG. 18C is a graph showing total alkene conversion as measured by 1H NMR for 1:1:0.05 (alkene:thiol:photoinitiator) samples in CDCl₃;

FIG. 19A is a graph showing complex moduli of crosslinked polyester films as functions of temperature;

FIG. 19B is a graph showing storage moduli.of crosslinked polyester films as functions of temperature;

FIG. 20 is a graph showing curve fitting of the complex moduli as a function of temperature at 0.1, 1 and 10 rad × s⁻¹ to obtain T_{g}.

FIG. 21A is a graph showing uniaxial tensile curves for an examined polyester sample, tested at 5 mm × min-1 at 20° C. under ambient atmosphere to failure;

FIG. 21B is a graph showing uniaxial tensile curves for an examined polyester sample, tested at 5 mm × min-1 at 20° C. under ambient atmosphere to failure;

FIG. 21C is a graph showing uniaxial tensile curves for an examined polyester sample, tested at 5 mm × min-1 at 20° C. under ambient atmosphere to failure;

FIG. 21D is a graph showing uniaxial tensile curves for an examined polyester sample, tested at 5 mm × min-1 at 20° C. under ambient atmosphere to failure;

FIG. 21E is a graph showing uniaxial tensile curves for an examined polyester sample, tested at 5 mm × min-1 at 20° C. under ambient atmosphere to failure;

FIG. 22A is a graph showing a representative cyclic tensile curve for the polyester films, tested at 5 mm × min⁻¹ at 20° C. under ambient atmosphere from 0 to 15% strain at variable temperatures;

FIG. 22A is a graph showing a representative cyclic tensile curve for the polyester films, tested at 5 mm × min⁻¹ at 20° C. under ambient atmosphere from 0 to 15% strain at variable temperatures;

FIG. 22B is a graph showing a representative cyclic tensile curve for the polyester films, tested at 5 mm × min⁻¹ at 20° C. under ambient atmosphere from 0 to 15% strain at variable temperatures;

FIG. 22C is a graph showing a representative cyclic tensile curve for the polyester films, tested at 5 mm × min⁻¹ at 20° C. under ambient atmosphere from 0 to 15% strain at variable temperatures;

FIG. 22D is a graph showing a representative cyclic tensile curve for the polyester films, tested at 5 mm × min⁻¹ at 20° C. under ambient atmosphere from 0 to 15% strain at variable temperatures;

FIG. 22E is a graph showing a representative cyclic tensile curve for the polyester films, tested at 5 mm × min⁻¹ at 20° C. under ambient atmosphere from 0 to 15% strain at variable temperatures;

FIG. 22F is a graph showing a representative cyclic tensile curve for the polyester films, tested at 5 mm × min⁻¹ at 20° C. under ambient atmosphere from 0 to 15% strain at variable temperatures;

FIG. 22G is a graph showing a representative cyclic tensile curve for the polyester films, tested at 5 mm × min⁻¹ at 20° C. under ambient atmosphere from 0 to 15% strain at variable temperatures;

FIG. 23 is a graph showing a representative cycle tension/compression test for the polyester films, strained at 5 mm × min⁻¹ at 20° C. under ambient atmosphere from 0 to 10% to -10% strain;

FIG. 24A is an image of the 3D printing porous structure evaluated for shape memory and resolution;

FIG. 24B is an image of the 3D printing porous structure evaluated for shape memory and resolution;

FIG. 24C is an image of the 3D printing porous structure evaluated for shape memory and resolution;

FIG. 24D is an image of the 3D printing porous structure evaluated for shape memory and resolution;

FIG. 24E is an image of the 3D printing porous structure evaluated for shape memory and resolution;

FIG. 25A is an oblique image depicting repeated layer structures;

FIG. 25B is a topographical heat map of a 3D printed porous structure shown in FIG. 25A;

FIG. 25C is an oblique image depicting repeated layer structures;

FIG. 25D is a topographical heat map of a 3D printed porous structure shown in FIG. 25C;

FIG. 25E is an oblique image depicting repeated layer structures;

FIG. 25F is a topographical heat map of a 3D printed porous structure shown in FIG. 25E;

FIG. 26 is a graph showing a representative selection of resins having various weight percentages of polystyrene;

FIG. 27A is a graph showing tensile properties of recycled/upcycled poly(myrcene);

FIG. 27B is a graph showing photorheology of recycled/upcycled resins;

FIG. 28 are ¹H NMR charts of poly(myrcene) materials before and after recycling;

FIG. 29A is a graph showing a rheological characterization on cis and trans states of the polyester using a standard temperature and flow sweep;

FIG. 29B is a graph showing an oscillatory temperature sweep conducted at an angular frequency of 10.0 rad × s-1, beginning at 5° C. and heating to 195° C. at a rate of 2° C. × min⁻¹;

FIG. 29C is a graph showing a frequency sweep conducted at a strain of 0.02 at 25° C. performed from 0.1 to 100 radians × sec⁻¹;

FIG. 29D is a graph showing a flow sweep performed by stepping the uni-rotational shear rate from 0.2 to 2000.0 s⁻¹ at 25° C. for 20 step increments;

FIG. 30A is a graph showing Tg comparison of PMPGE and PFPGE with increasing photopolymer resin off-stoichiometric ratio run via a DSC on a temperature sweep ranging from -90° C. to 170° C. at a rate of 10° C./min;

FIG. 30B is a graph showing Tg comparison of PMPGE and PFPGE with increasing photopolymer resin off-stoichiometric ratio run via a DSC on a temperature sweep ranging from -90° C. to 170° C. at a rate of 10° C./min;

FIG. 30C is a graph showing changes in storage modulus vs. temperature for selected samples run via a DMA on a temperature sweep ranging from -30° C. to 220° C. at a constant load of 0.01 N and a frequency of 10 Hz;

FIG. 30D is a graph showing changes in storage modulus vs. temperature for selected samples run via a DMA on a temperature sweep ranging from -30° C. to 220° C. at a constant load of 0.01 N and a frequency of 10 Hz;

FIG. 31A is a graph showing rheological comparison of photopolymer resins using a standard flow sweep by stepping the uni-rotational shear rate from 0.2 to 2000.0 s⁻¹ at 25° C. for 20 step increments stoichiometrically balanced resins up to a 30:1 off stoichiometric ratio using PMPGE;

FIG. 31B is a graph showing rheological comparison of photopolymer resins using a standard flow sweep by stepping the uni-rotational shear rate from 0.2 to 2000.0 s⁻¹ at 25° C. for 20 step increments stoichiometrically balanced resins up to a 30:1 off stoichiometric ratio using PFPGE;

FIG. 32A is a graph showing tensile testing of photopolymer resin dog bones with a cross sectional area measuring 1.5 mm × 4.0 mm × 10 mm, and all formulations are made using 25 wt% trione;

FIG. 32B is a graph showing tensile testing of photopolymer resin dog bones with a cross sectional area measuring 1.5 mm × 4.0 mm × 10 mm, and all formulations are made using 25 wt% trione;

FIG. 33A is a graph of strain recovery rate of films at testing temperatures of 37, 50, 75, 100, and 125° C. for PMPGE 1:1 and PFPGE 1:1;

FIG. 33B is a graph of strain recovery rate of films at testing temperatures of 44, 60, 90, 120, and 150° C. for PFPGE 30:1 and 63, 85, 126, 169, and 211° C. for PMPGE 30:1;

FIG. 33C is a graph showing the time at which each film reached 95% strain recovery for all formulations was quantified at the temperatures previously stated regarding FIGS. 33A and 33B;

FIG. 33D is a graph showing strain fixation on the films over a twelve-hour period time window in room temperature;

FIG. 33E shows a sample progression of PMPGE 1:1 undergoing 100% strain recovery at 50° C.

FIG. 34A is an isometric view of a keyence microscope image of 3D printed scaffolds of PFPGE 1:1 via digital light processing;

FIG. 34B is an oblique view of a keyence microscope image of 3D printed scaffolds of PFPGE 1:1 via digital light processing;

FIG. 34C is a top view of a keyence microscope image of 3D printed scaffolds of PFPGE 1:1 via digital light processing; and

FIG. 34D shows a graph of an accelerated gravimetric analysis performed on the 1:1, 1.1:1, 1.5:1, and 10:1 off stoichiometric ratios of the PMPGE and PFPGE photocrosslinked films.

### DETAILED DESCRIPTION

One or more specific embodiments of the present invention will be described below. In an effort to provide a concise description of these embodiments, all features of an actual implementation may not be described in the specification. It should be appreciated that in the development of any such actual implementation, as in any engineering or design project, numerous implementation-specific decisions must be made to achieve the developers’ specific goals, such as compliance with system-related and business-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

All ranges used herein included the endpoints of the range as suitable values of parameter described with the range. It is understood that participants in the art may differentiate between resins, inks, or resin-inks, based at least on the viscosities of these components. As used herein, the term “resin”, “ink”, or “resin-ink” each refer to any and all of resins, inks, or resin-inks, as used in the art.

As noted above, various aspects of the present invention provide a 3D printable resin, a ring-opened polyester copolymer, and a 3D printable resin using the ring-opened copolymer. The embodiments described below are not intended to limit the scope of the invention to the embodiments explicitly described, but are included to serve as examples of the invention disclosed herein.

In an embodiment, a 3D printable resin is provided. The 3D printable resin includes a polystyrene and at least one of a solubilizing crosslinker or a solubilizing polymer.

In another embodiment, a ring-opened polyester copolymer is provided. The ring-opened polyester copolymer is a product of a reaction between a cyclic anhydride and an epoxide, such as cyclohexene anhydride and a glycidol allyl ether.

In another embodiment, a polyester resin is provided. The polyester resin includes a product of a reaction between a cyclic anhydride and an epoxide, such as cyclohexene anhydride and a glycidol allyl ether, a multi-arm thiol, such as a 4-arm thiol, and a photoinitiator.

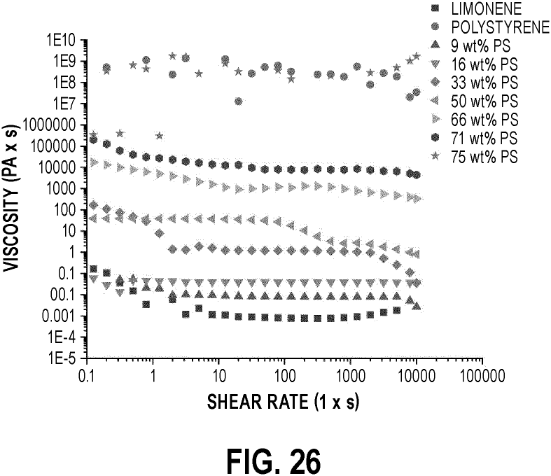

In that regard, and with respect to the upcycling of polystyrene-reinforced 3D printable photopolymer nanocomposites: As note above, it has been previously reported that PS is soluble in limonene, and that limonene, along with other terpenes including myrcene, polymyrcene, terpinene, nerol, linalool and geraniol, could be used to produce 3D printing resins with various thermomechanical properties. The inclusion of PS was used by the present inventors to provide a means of overcoming the limitation of terpene-based photopolymer resins, namely that low viscosity limited the curing into solid structures upon photoirradiation. By increasing the concentration of the PS in the limonene, the present inventors noted that viscosity could be increased by several orders of magnitude without impacting the photocuring rate. FIG. 26 is a graph showing a representative comparative formulations of PS/limonene resins. As shown in FIG. 26, the viscosity of the resin increases as the wt% of PS in the resin increases. As will be shown with greater detail below (in the Examples), this was repeated with a library of naturally-occurring and synthetic terpenes/terpenoids, as well as synthetic polyesters made via ring opening copolymerization (ROCOP). Furthermore, viscosity tests were conducted on polymers derived from terpenes/terpenoids, modified monomers, poly/oligomers, and resins to include functional groups including allyl-,epoxide-, and other moieties such as acrylate, methacrylate, and alkyne. All of these viscosity tests showed increased viscosity of the resin with increased viscosity of polystyrene. In an example, a suitable polymer derivation is shown below:

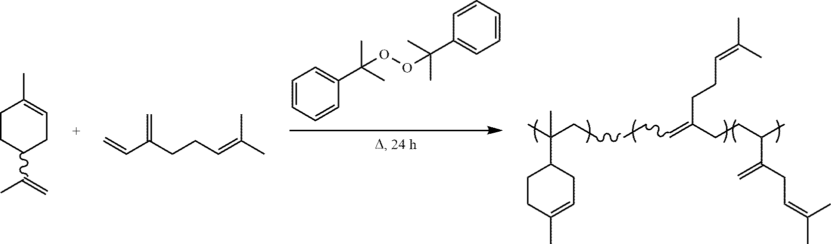

Variation in the structure of the monomers/polymers was used to achieve different solubility upper limits, with more hydrophilic structures including alcohols (linalool) and hydrogen bonding moieties (urethane linkages) decreasing both the rate of PS solubilization as well as the maximum amount possible to solubilize with the solute. For example, linalool allyl ether was capable of dissolving some small amount of PS.

Other examples of designed monomers which can be used to dissolve PS include salicylic acid (and salicylaldehyde) derivatives, vanillin derivatives, lignans and neolignans, and similar phenolic natural products. While the natural products themselves are less likely to dissolve PS (due to physical form as well as the presence of alcohols, acids, amines, and other functional groups), modification of these products to include ester and ether allyl bonds was found to be effective for facilitating their solubilization of PS.

In an example, a polystyrene solubilizing crosslinker is used to solubilize the PS in solution. Examples of suitable polystyrene solubilizing crosslinkers may be selected from a group consisting of limonene, limonene di(thioether propanoic allyl ester), limonene di(thioether propanoic acid), myrcene, polymyrcene, linalool allyl ether, dilinalool IPDI, dilinalool HDI, trilinalool phosphate, eugenol, dieugenol HDI, dieugenol IPDI, and combinations thereof. Other suitable polystyrene solubilizing crosslinkers may be used, and all suitable polystyrene solubilizing crosslinkers are not necessarily explicitly listed above.

Alternatively or in addition, the 3D printable resin includes a solubilizing polymer in which polystyrene is soluble. In some examples, the solubilizing polymer may be selected from a group consisting of a compound having a structure of:

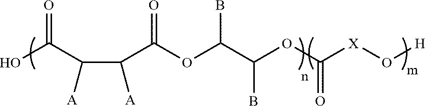

where A is a functional group selected from a group consisting of at least one of the following functional groups:

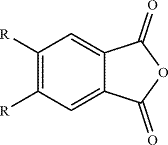

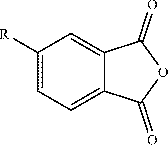

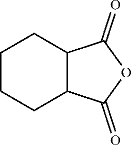

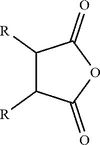

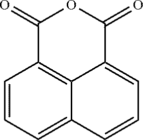

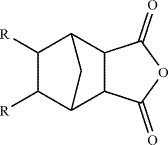

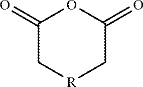

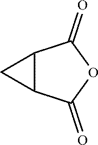

where B is a functional group selected from a group consisting of at least one of the following functional groups:

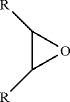

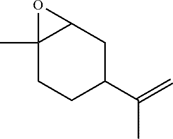

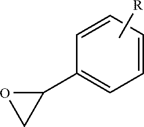

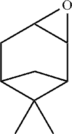

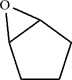

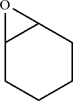

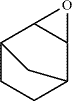

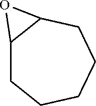

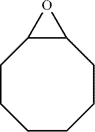

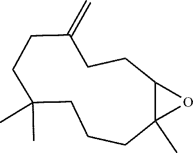 [SMILES: C=C1CCC2OC2(C)CCCC(C)(C)CC1]

and where R is a functional group comprising an aryl or alkyl, saturated or unsaturated, carbon chain or carbon ring, the carbon chain or the carbon ring including either a non-substituted moiety or a substituted moiety.

And so, one aspect of the present invention is directed to a 3D printable resin comprising a polystyrene; and at least one of a solubilizing crosslinker or a solubilizing polymer.

In an embodiment, the 3D printable resin comprises the solubilizing crosslinker, and the solubilizing crosslinker is selected from a group consisting of limonene, limonene di(thioether propanoic allyl ester), limonene di(thioether propanoic acid), myrcene, polymyrcene, linalool allyl ether, dilinalool IPDI, dilinalool HDI, trilinalool phosphate, eugenol, dieugenol HDI, dieugenol IPDI, and combinations thereof.

Further, the 3D printable resin may comprise the solubilizing polymer, and the solubilizing polymer is selected from a group consisting of a compound having a structure of:

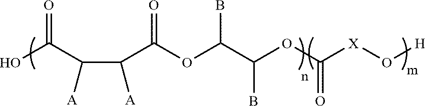

where A is a functional group selected from a group consisting of at least one of the following functional groups:

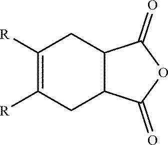

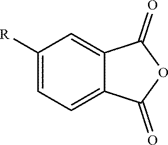

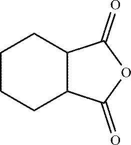

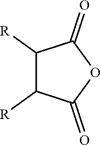

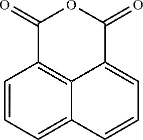

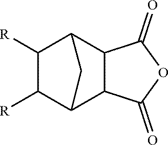

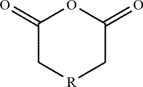

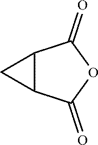

where B is a functional group selected from a group consisting of at least one of the following functional groups:

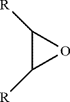

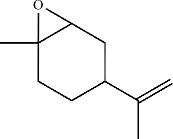

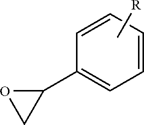

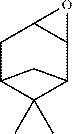

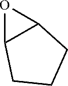

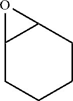

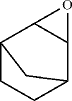

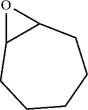

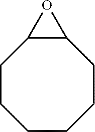

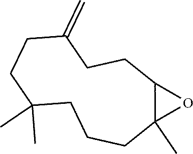 [SMILES: C=C1CCC2OC2(C)CCCC(C)(C)CC1]

and where each R is independently a functional group comprising an aryl or alkyl, saturated or unsaturated, substituted or non-substituted, carbon chain or carbon ring.

In certain embodiments, the 3D printable resin is photocurable.

In certain embodiments, the 3D printable resin is active to a wavelength in a purple-blue region and a wavelength in an ultraviolet region.

In certain embodiments, at least one of the solubilizing crosslinker or the solubilizing polymer is formed via a ring opening copolymerization process.

In certain embodiments, the resin includes poly (butylene-co-norbornene), poly (styrene-co-norbornene), poly (styrene-co-norbornene), poly (butylene-co-norbornene), poly(styrene-co-norbornene), poly(butylene-co-norbomene), poly(styrene-co-norbornene), or poly(styrene-co-norbornene).

In certain embodiments, the resin includes norbornene allyl ester, 2-[1-(prop-2-en-1-yloxy)ethynyl]phenyl propyl carbonate, 2-[(Z)-[(prop-2-en-1-yl)imino]methyl]phenol, or D-limonene.

In one particular embodiment, the 3D printable resin may further comprise a photoinitiator; a photoinhibitor; and a pentaerythritol tetrakis(3-mercaptopropionate).

Now, with respect to ring opening copolymerization (ROCOP) to produce 4D printable shape memory polyesters, and as will be demonstrated in greater detail in the Examples: ROCOP was used by the present inventors to produce linear polyesters from epoxides and cyclic anhydrides, with reactive allyl and cyclohexene functionalities which may be used to produce crosslinked networks. Thiol-ene click chemistry crosslinking was found to occur rapidly enough to support DLP-type 3D printing of the photopolymer formulations, and was used to produce 3D porous structure prototypes and dogbones for mechanical analysis. Variations in the polymers and the crosslinking density could be used to vary the mechanical behavior of the polymer, with the Polyester formulation displaying the greatest mechanical stability, as well as shape memory due to its higher-than-room temperature T_{g} and glassy network. In fact, the high rigidity of the network on a macroscopic scale is hypothesized to be the result of some of the fracturing found during shape memory testing, however the crosslinked network is robust enough to maintain and stabilize its shape even with multiple fractures of the 3D monolithic structure, indicating the promise of these materials in 3D printing for a variety of biomedical and other applications.

ROCOP was leveraged to produce triblock copolymers with additional functional groups to achieve multifunctional materials. Thiol-ene click reactions were used to react the alkene moieties of both cyclic monomers with mercaptopropanoic acid, producing cyclic monomers with carboxylic acid side chains. An example of polyester copolymers formed are shown below:

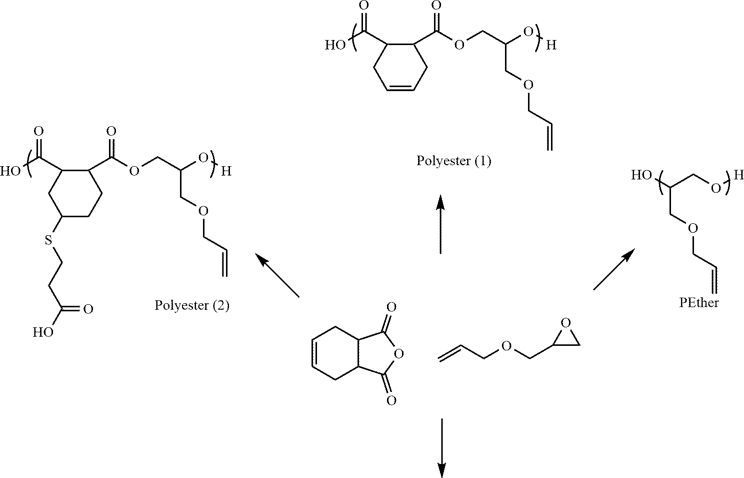

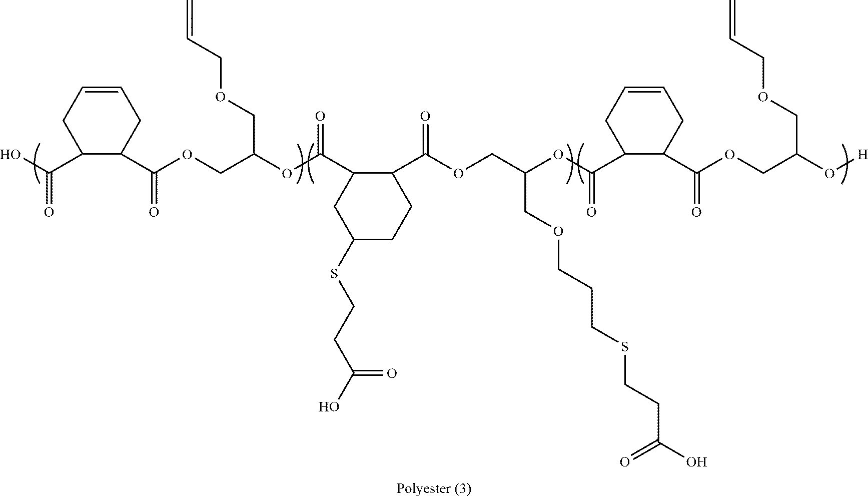

Other polyester copolymers may be formed by substituting the monomer reactant shown above with a different, desired monomer.

A synthetic scheme for producing triblock polyester copolymers is shown below:

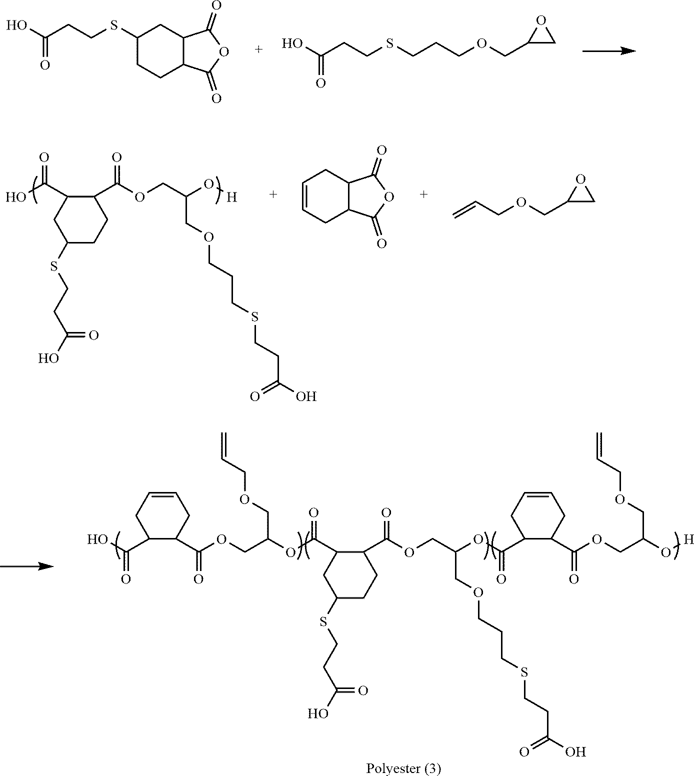

And so, in various embodiments, a ring-opened polyester copolymer may comprise a product of a reaction between a cyclic anhydride and an epoxide, such as cyclohexene anhydride and a glycidol allyl ether.

In certain embodiments, the ring-opened polyester copolymer has a molecular weight of between 1.0 kDa and 250 kDa. In another embodiment, the ring-opened polyester copolymer has a molecular weight of between 16.0 kDa and 23.7 kDa.

In certain embodiments, the ring-opened polyester copolymer has a carboxylic acid endgroup and an alcohol endgroup.

In certain embodiments, the ring-opened polyester copolymer has an allyl function group and a cyclohexene functional group within a polymer chain.

In certain embodiments, the ring-opened polyester copolymer is a color having an ultraviolet-visible absorption relative maxima at between about 350 nm and about 500 nm. In another embodiment, the ring-opened polyester copolymer is a color having an ultraviolet-visible absorption relative maxima of about 455 nm.

In certain embodiments, the ring-opened polyester copolymer is a color having an ultraviolet-visible absorption relative maxima at between about 350 nm and about 500 nm and a full width at half maximum range of about 20 nm. In another embodiment, the ring-opened polyester copolymer is a color having an ultraviolet-visible absorption relative maxima of about 455 nm and a full width at half maximum range of about 20 nm.

In certain embodiments, the ring-opened polyester copolymer has a glass transition temperature tunable from 0° C. to 250° C.

Other aspects of the present invention may include polyester resin comprising a product of a reaction between a cyclic anhydride and an epoxide , such as cyclohexene anhydride and a glycidol allyl ether; a multi-arm thiol, such as a 4-arm thiol,; and a photoinitiator. Various aspects may also include a structure formed by a 3D printing of this polyester resin. This structure may exhibit shape memory behavior.

In certain embodiments, the 4-arm thiol is a pentaerythritol tetrakis(3-mercaptopropionate).

In certain embodiments, the photoinitiator is Irgacure 819.

In certain embodiments, the polyester resin is 3D prinatable.

The various aspects of the present invention will be further described in the Examples below.

### EXAMPLES

### Example 1: Upcycling of Polysteyrene-Reinforced 3D Printable Photopolymer Nanocomposites

### A. Methods and Materials

1. General Considerations: All chemicals were commercially available (purchased from Sigma-Aldrich, having its headquarters in St. Louis, MO, USA, unless otherwise stated) and used without further purification. Solvents were of ACS grade or higher. NMR spectra (400 MHz for ¹H and 125 MHz for ¹³C) were recorded on a Bruker 400 spectrometer and processed using MestReNova v9.0.1 (Mestrelab Research, S.L., Santiago de Compostela, Spain). Chemical shifts were referenced to residual solvent peaks at δ = 7.26 ppm (¹H) and δ = 77.16 ppm (¹³C) for CDCl₃.

2. General Synthesis of Resins from Terpenes: The monomeric terpene (limonene, 1.0 g, 7.3 mmol) and PETMP (1.719 g, 3.6 mmol) were dissolved in acetone (5 mL). Irgacure 819 (40.5 mg, 1.5% wt, 0.1 mmol) was added to the mixture in the absence of ambient light and left without stirring for 12 h. To this solution, photoinhibitor (Kalsec Durabrite® Oleoresin Paprika Extract NS, 1 mL) was added and mixed until homogenized.

3. General Synthesis of Resins from Terpene Prepolymers: To the prepolymer resin was added the remaining half measure of thiol was. As an example, nerol prepolymer (1.76 g) and PETMP (0.76 g, 1.6 mmol) were dissolved in acetone (0.28 g). To this solution was added Irgacure 819 (0.113 g, 0.3 mmol) photoinhibitor 1 mL). The solution was allowed left without stirring overnight in a brown glass vial before any testing. Aliquots were taken using a pipette at various time intervals for ¹H NMR spectroscopic analysis until the mixture became too viscous to sample.

4. Polyester Synthesis: ROCOP was performed based upon established literature protocols using stannous octoate and heat in sealed vials. The synthesis was performed at both small (approximately 1 g) and large (approximately 200 g) scale, with variation in the mass of the reagents but not the reaction stochiometry. Variation in polymer structure were achieved by using functionalized anhydride monomers (with mercaptopropanoic acid “clicked” onto the cyclohexene moiety prior to ROCOP) to produce alternating copolymers, as well as functionalization of oligomeric polyester to produce triblock copolymers.

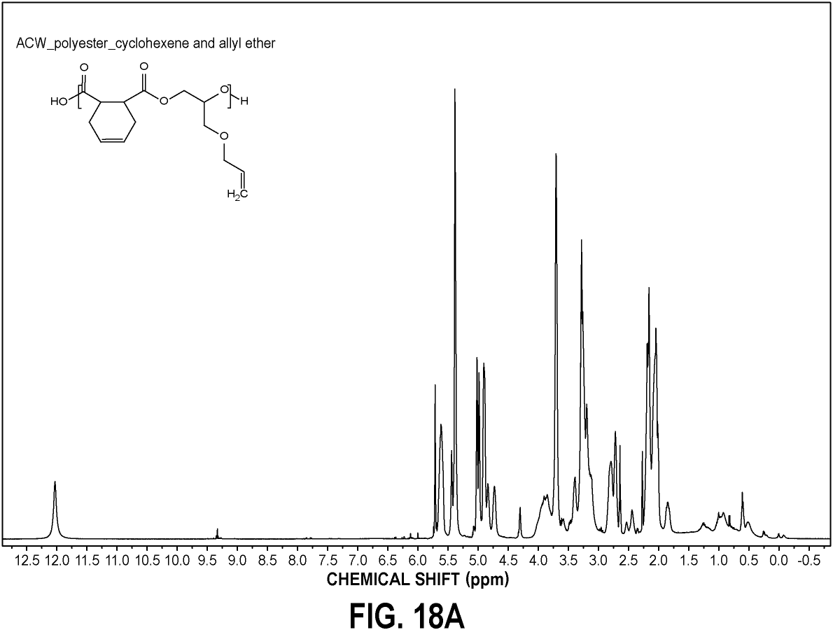

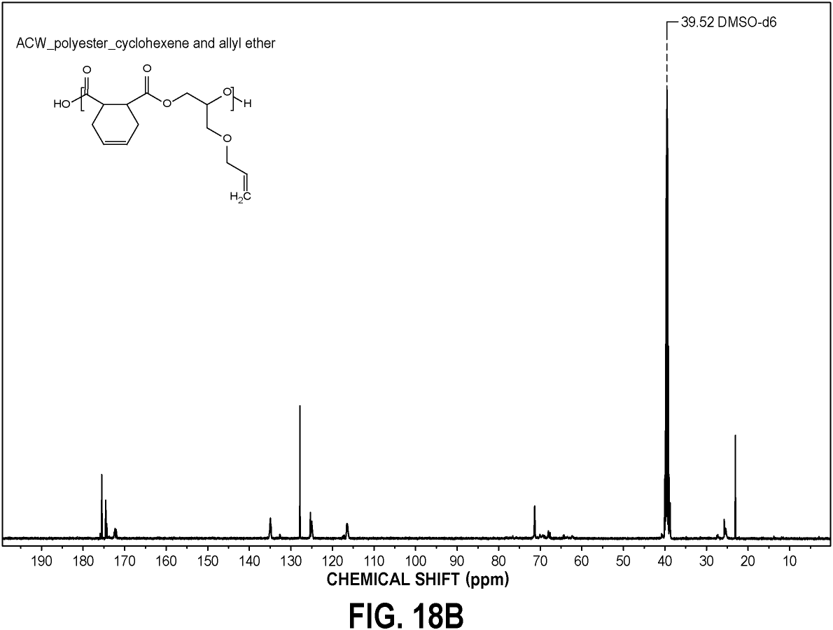

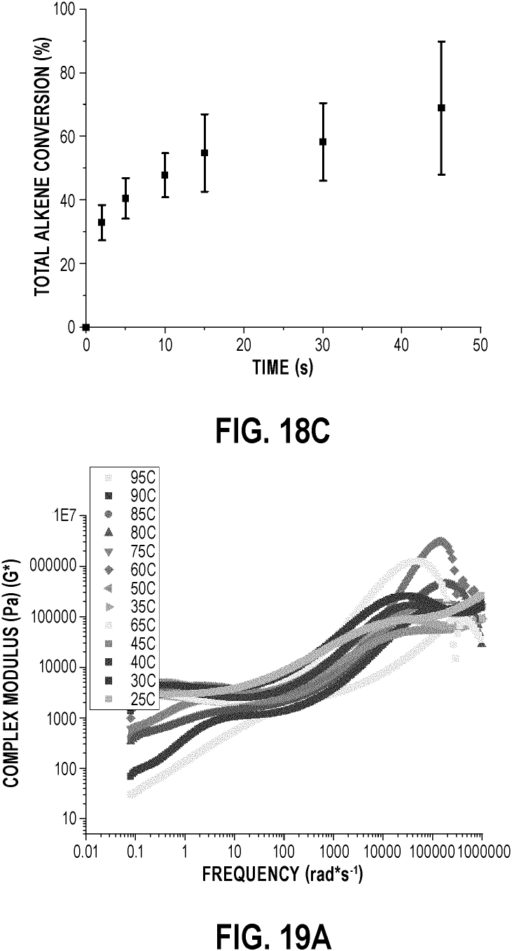

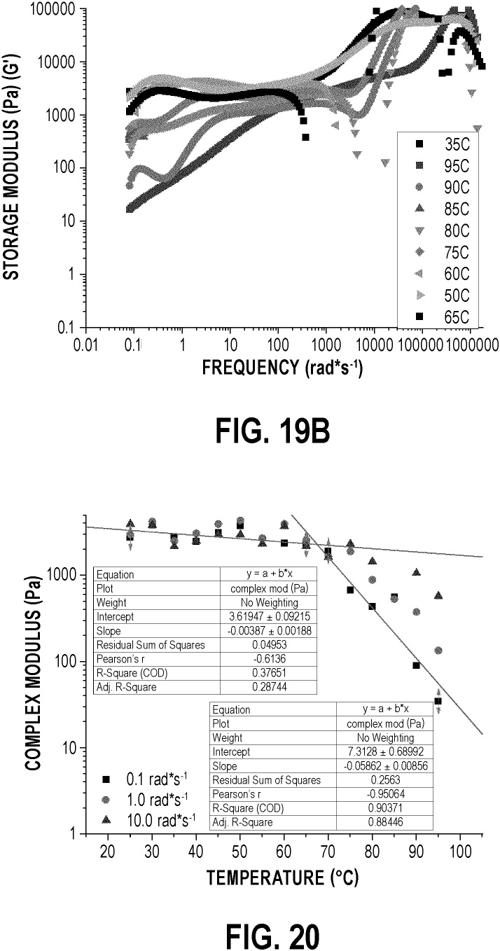

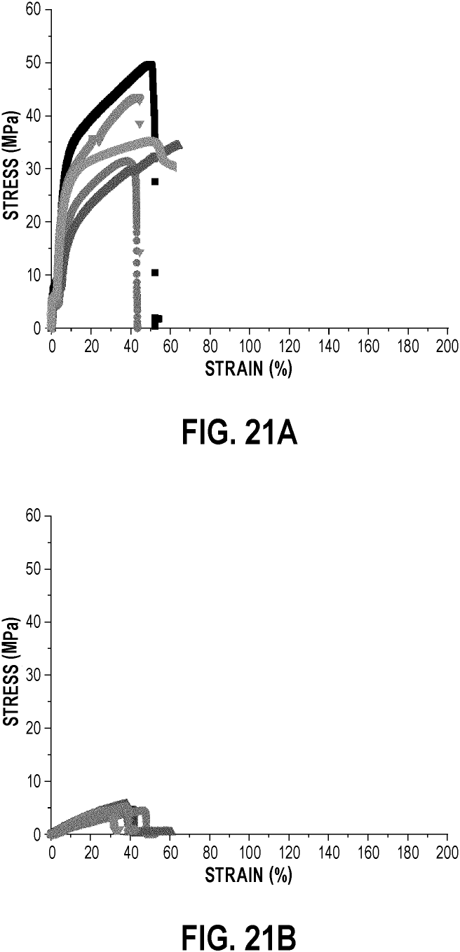

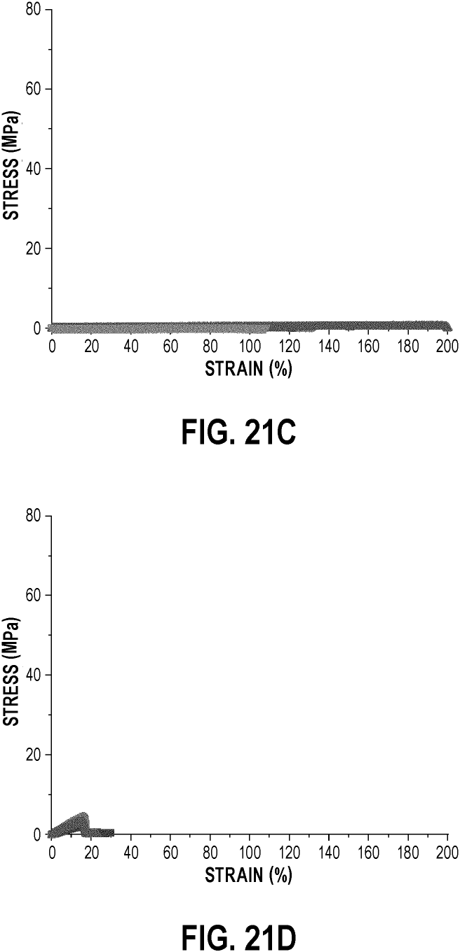

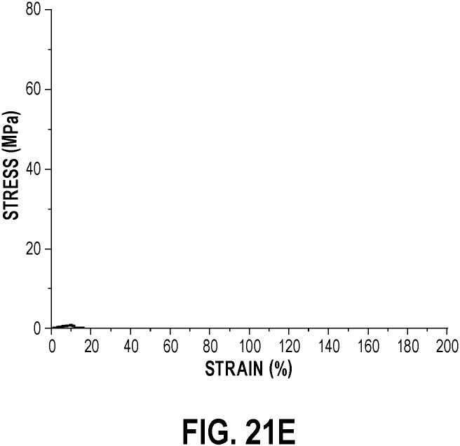

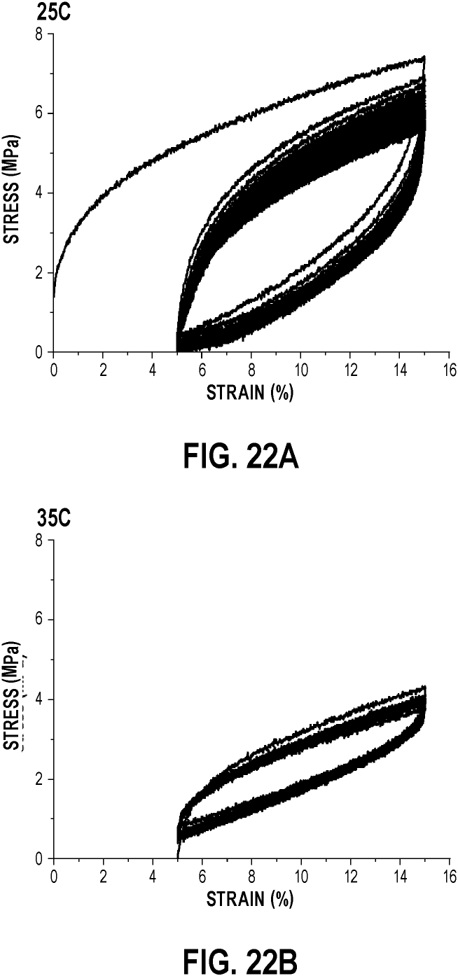

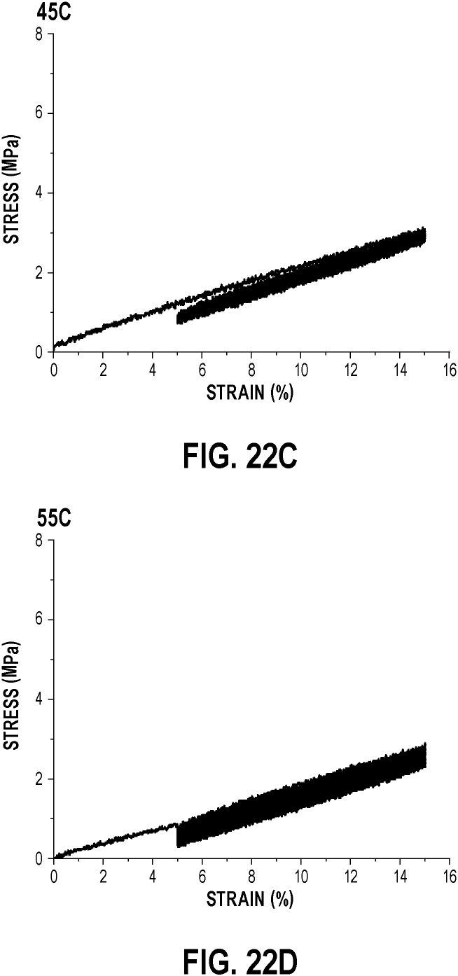

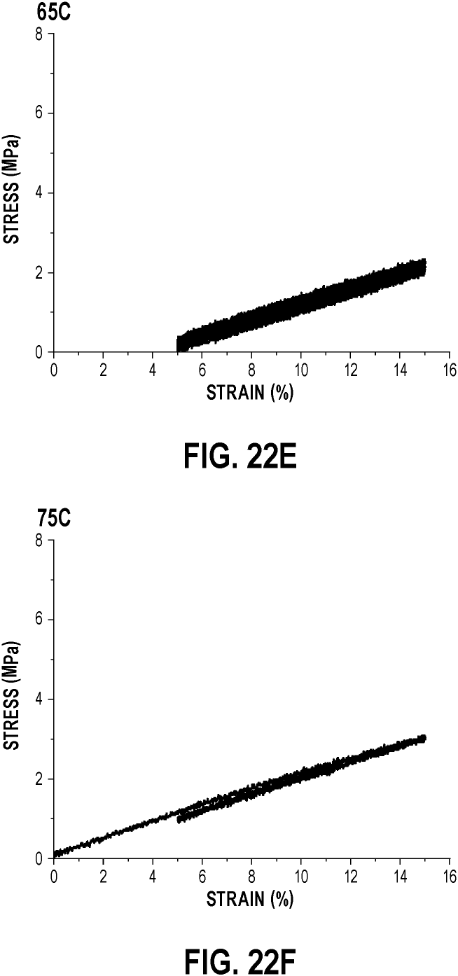

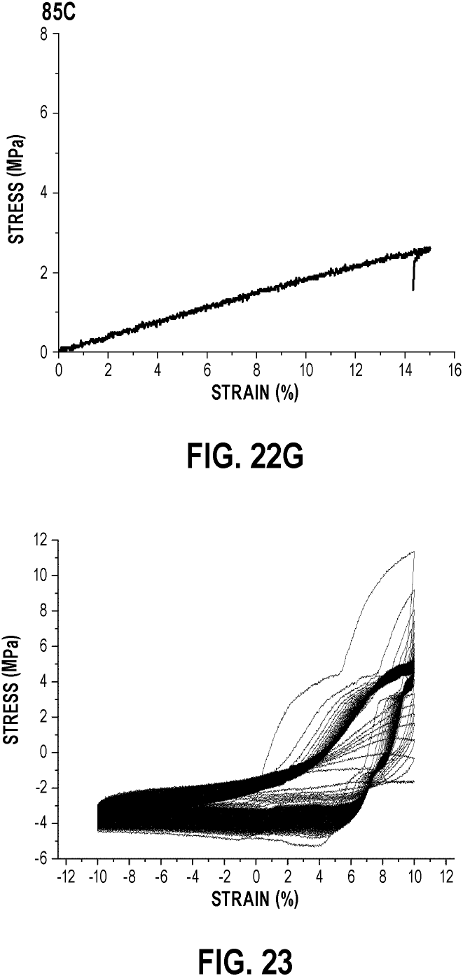

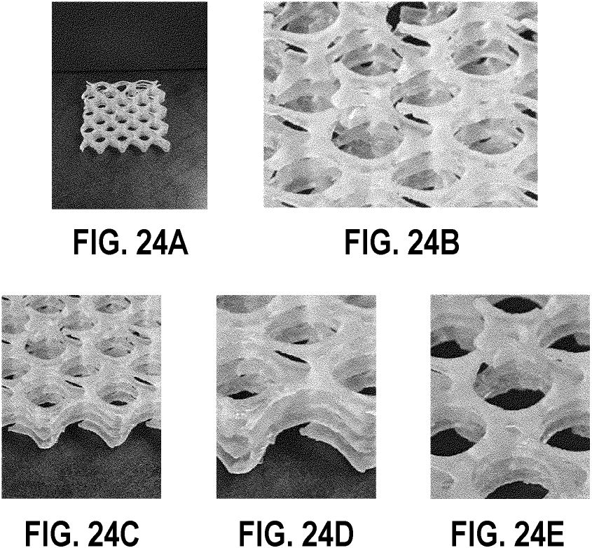

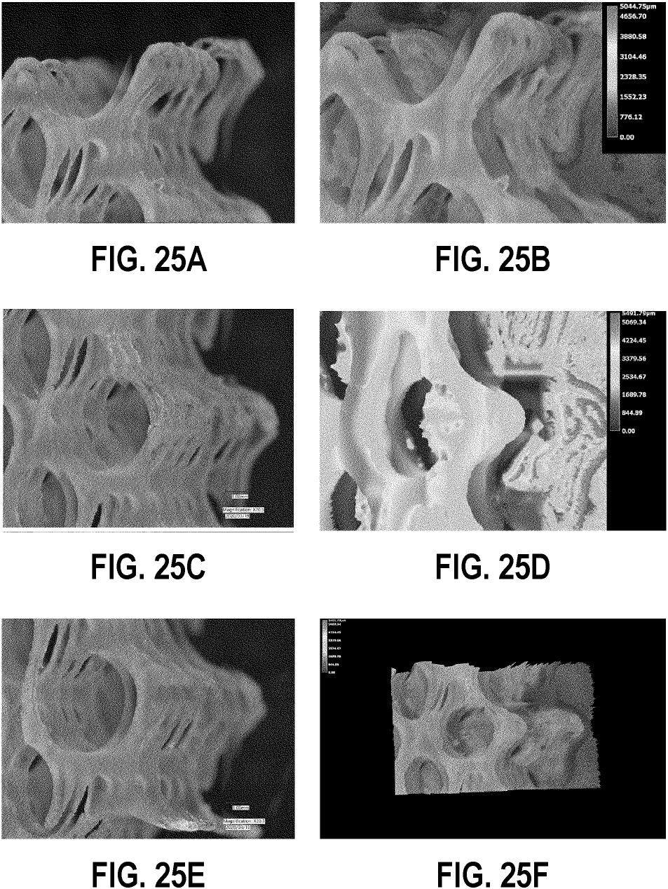

Small scale synthesis: Cyclohexene dicarboxylic anhydride and glycidol allyl epoxide were added to a sealed vial at room temperature, along with stannous octoate. The vial was heated in an oil bath to 150° C. and allowed to stir for 48 h before cooling to room temperature. The viscous oil was collected and analyzed by NMR (FIGS. 18A and 18B)

5. Post-Polymerisation Treatment: Solid polymers were cured for 12 h at 30° C., 80° C. or 120° C. prior to testing. Samples were photocured for 30 mins under ambient conditions and then placed in an isothermal oven at standard atmospheric pressure and moisture. After the cure cycle, samples were removed and allowed to cool to room temperature over 12 h prior to additional testing.

6. 3D Printing: Scaffolds based upon previously reported geometries were printed from resins using varied conditions dependent upon composition. Resins were added in 100 mL quantities to the resin tray, allowing for complete and even coverage of the optical window and the surface of the printing plate. Porous scaffolds were printed by applying the photomask (MiiCraft 50x, BURMS, Jena, Germany) with a λ = 365 nm light source. Per slice time was varied according to photorheology experiments to produce robust solid structures which could support subsequent polymer.

7. Thermomechanical characterization: Thermal and rheological analysis was performed using a DWS Rheolab optical rheometer (LS Instruments, Fribourg, Switzerland). Solid and liquid samples were placed in the 10 mm vial and were thermally equilibrated across a temperature range from 0 to 100° C. in 5° C. increments. Thermal transitions were determined from storage modulus and tan δ, based upon previous work comparing different behaviors in crosslinked polymer networks.

Uniaxial tensile testing to failure was conducted using an Instron with a 100 kg load cell. The printed dogbone samples (modified ASTM Type IV) were placed in the grips and pulled at 5 mm × min⁻¹ until failure, with a minimum of 5 samples per composition tested. For select compositions, the temperature was varied using a customized heating cell which allowed for sample incubation during testing, where samples were heated to the desired temperature, held isothermally for 5 min, and then tested at the previously described rate.

Cyclic testing to failure was conducted using two different methods: uniaxial tension and tension/compression. In both modalities, the same 3D printed dogbones were used. For cyclic tension, samples were deformed to 15% strain and allowed to relax to 5% strain before being strained again. Samples were cycled between these strains at 5 mm × min⁻¹, and the role of temperature was examined by testing at 20° C. and 65° C., selected by their distance from the material T_{g}. Tension/compression studies were performed by extending the samples to 10% strain, followed by compression to 10% (-10% tensile strain) at 5 mm × min⁻¹.

8. Shape memory behavior of polyesters: Shape memory behavior was characterized both with 3D printed dogbones as well as by using the porous printed structures. For dogbones, samples were placed in the tensile clamps and heated to 50° C., after which the samples were allowed to thermally equilibrate for 5 minutes. Samples were then uniaxially stretched to 22.5% strain at variable rates, at which point the samples were cooled to 0° C. using a customized apparatus. The tensile load was released and the grips were returned together at the same rate as the deformation. Comparisons of the rate of deformation were used to determine the rate of recovery.

### B. Results and Discussion

It has been previously reported that PS is soluble in limonene, and that limonene, along with other terpenes including myrcene, polymyrcene, terpinene, nerol, linalool and geraniol, could be used to produce 3D printing resins with various thermomechanical properties. The inclusion of PS was demonstrated here to provide a means of overcoming the limitation of terpene-based photopolymer resins, namely that low viscosity limited the curing into solid structures upon photoirradiation. By increasing the concentration of the PS in the limonene, viscosity could be increased by several orders of magnitude without impacting the photocuring rate. This was repeated with a library of naturally-occurring and synthetic terpenes/terpenoids, as well as synthetic polyesters made via ring opening copolymerization (ROCOP). Variation in the structure of the monomers/polymers was used to achieve different solubility upper limits, with more hydrophilic structures including alcohols (linalool) and hydrogen bonding moieties (urethane linkages) decreasing both the rate of PS solubilization as well as the maximum amount possible to solubilize with the solute. Linalool and its urethane-containing derivatives, for instance, would not dissolve any qualitative amount of PS even at 50° C. However, linalool allyl ether was capable of dissolving some small amount of PS. By comparison, limonene has a reported solubility of PS greater than 0.2 g/mL at room temperature.

Other examples of designed monomers which can be used to dissolve PS include salicylic acid (and salicylaldehyde) derivatives, vanillin derivatives, and similar phenolic natural products. While the natural products themselves are less likely to dissolve PS (due to physical form as well as the presence of alcohols, acids, amines, and other functional groups), modification of these products to include ester and ether allyl bonds was found to be effective for facilitating their solubilization of PS.

In an example, a polystyrene solubilizing crosslinker is used to solubilize the PS in solution. Examples of suitable polystyrene solubilizing crosslinkers may be selected from a group consisting of limonene, limonene di(thioether propanoic allyl ester), limonene di(thioether propanoic acid), myrcene, polymyrcene, linalool allyl ether, dilinalool IPDI, dilinalool HDI, trilinalool phosphate, eugenol, dieugenol HDI, dieugenol IPDI, and combinations thereof. Other suitable polystyrene solubilizing crosslinkers may be used, and all suitable polystyrene solubilizing crosslinkers are not necessarily explicitly listed above.

Alternatively or in addition, the 3D printable resin includes a solubilizing polymer in which polystyrene is soluble. In some examples, the solubilizing polymer may be selected from a group consisting of a compound having a structure of:

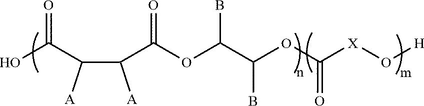

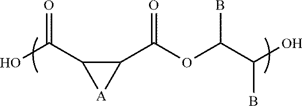

where A is a functional group selected from a group consisting of at least one of the following functional groups:

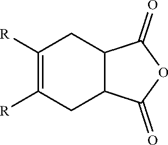

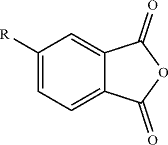

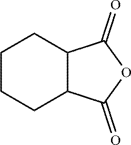

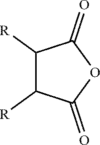

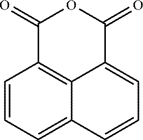

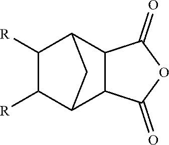

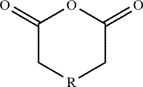

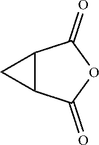

where B is a functional group selected from a group consisting of at least one of the following functional groups:

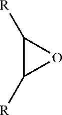

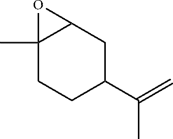

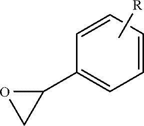

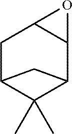

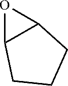

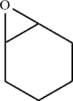

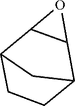

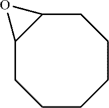

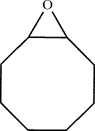

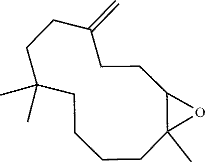 [SMILES: C=C1CCC2OC2(C)CCCCC(C)(C)CC1]

and where R is a functional group comprising an aryl or alkyl, saturated or unsaturated, carbon chain or carbon ring, the carbon chain or the carbon ring including either a non-substituted moiety or a substituted moiety.

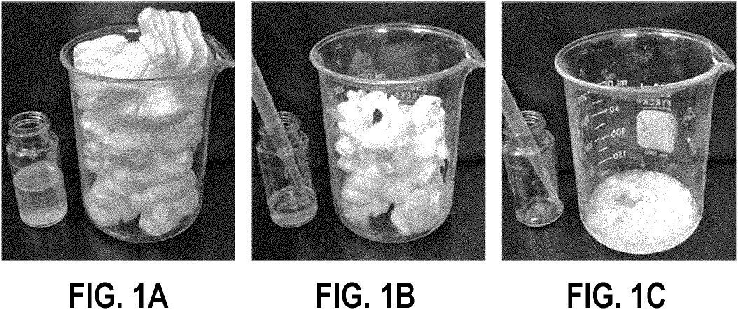

In solution, FIGS. 1A-1C show photographs of a resin solubilizing polystyrene. The 3D printable resin may include the polystyrene solubilizing crosslinker or the polystyrene solubilizing polymer, the polystyrene, a PETMP (4 arm thiol), a photoinhibitor (lutein solution, 30%) and a photoinitiator (Irgacure 819, Irgacure 784, etc). Shown below is an example of components included in the 3D printable resin.

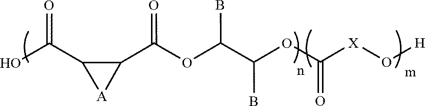

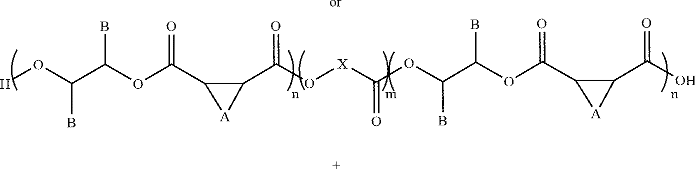

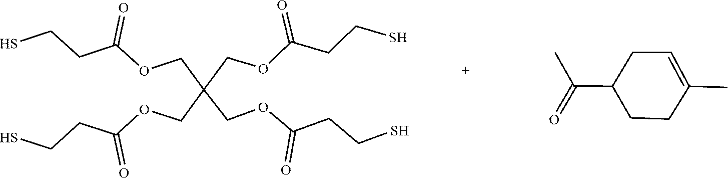

where A and B are as described above, n is between 1 and 1000, m is between 1 and 1000, m and n are independent of each other, and X represents commodity or common polymers such as, but not necessarily limited to, a polymer selected from a group consisting of polyesters, (poly(lactic acid), poly(glycolic acid), poly(caprolactone), poly(ethylene terephthalate), and combinations thereof.

The synthesized polyesters could also be used to dissolve PS, with different structures providing different solubilities at different temperatures. For instance, polyesters that incorporate the styrene moiety are more likely to dissolve PS compared with repeat units that are less hydrophobic, such as those with alcohols, carboxylic acids, or similar functional groups. The versatility of this ROCOP-synthesized polyester system is immense for PS recycling, as the library of commercially available epoxides is supplemented by alkenes which may be oxidized to epoxides, as well as dicarboxylic acids which may be transformed into cyclic dicarboxylic acid anhydrides. Finally, functional monomers, such as allyl glycidol epoxide, may be used to produce polyesters, followed by sequential functionalization using hydrophobic moieties such as thiol-laden hydrocarbon chains or phenolic compounds. These may be used to greatly enhance the polymer’s ability to solubilize PS.

These composite solutions (PS and reactive crosslinker or polymer) could then be added to PETMP (4 arm thiol), a photoinhibitor (lutein solution, 30%) and a photoinitiator (Irgacure 819, Irgacure 784, etc). Upon homogenization, a photopolymer resin active in the purple-blue and UV regions was produced, with solidification of the resin achievable within seconds upon exposure to 405 nm light (10 W) with a 1:1 inhibitor:initiator ratio and 1% wt photoinitiator in the resin. More importantly, the solubilization of the PS was possible by first synthesizing the resin (no PS present) and then adding the PS. The 3D printing was still found to be the same with this protocol.

In some examples, the mechanism for recycling of PS is given by the mechanism described below:

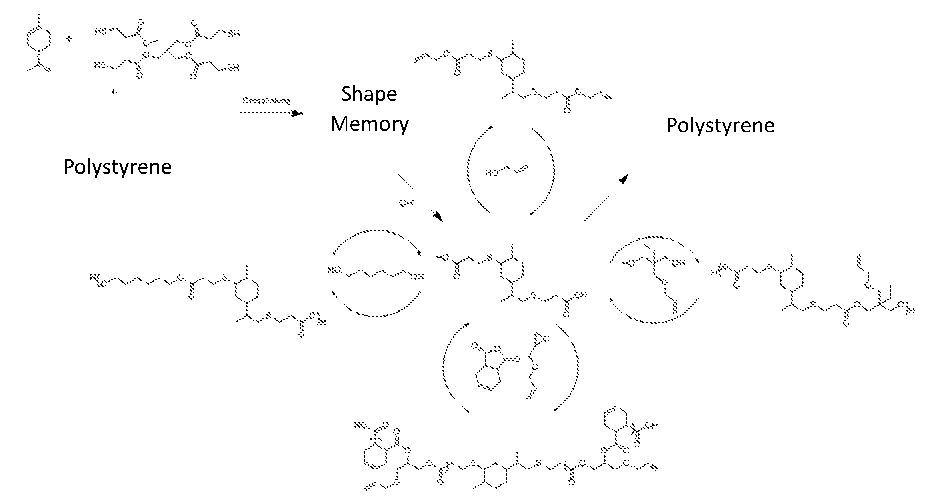

The photopolymers themselves may be produced using a wide array of different components. The polyester component may be used to instill greater thermomechanical stability, while low molecular crosslinkers such as salicylic acid allyl ester allyl ether can be used to produce very soft, compliant materials. Shape memory may be included with the additional of hydrogen-bonding containing components such as those with urethane linkages, however this reduces the ability of the resin to solubilize PS effectively.

The photopolymer matrix material is susceptible to hydrolysis due to the numerous ester linkages present in the PETMP molecule. Upon photocrosslinking during a digital light processing process (DLP process), the resulting thermoset network retains the hydrolysis-labile ester as well as the stabile thioether linkage. In the case of the polymyrcene (PM), where stoichiometry may be adjusted to retain the internal alkenes or the geranyl-like side-chains, alkenes are retained after hydrolysis. After isolation and cleaning the degraded PM, functionalized now with some measure of pendant carboxylic acid groups, the PM may again be added to a PETMP solution and photocrosslinked without any modifications required. In fact, the solubilization of the PM is increased in the PETMP in this case (at the expense of the solubility of the PS). The number of recycling processes possible with PM will be dependent upon a ratio of PM:PETMP used for each photopolymerization, as well as the decreasing solubility of PS in the resin.

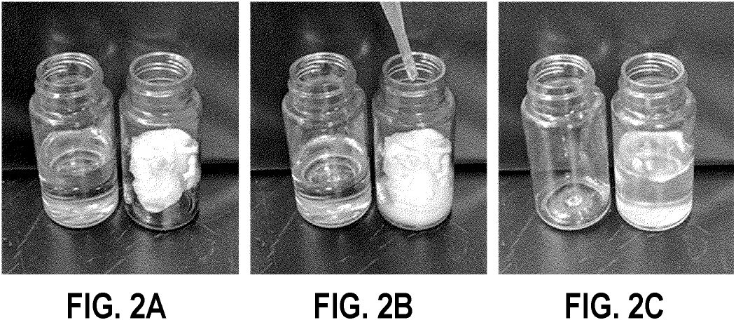

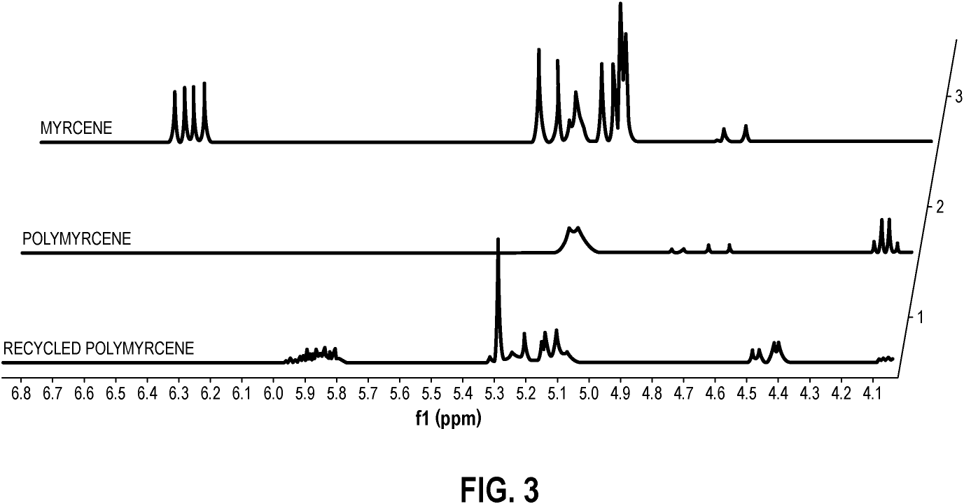

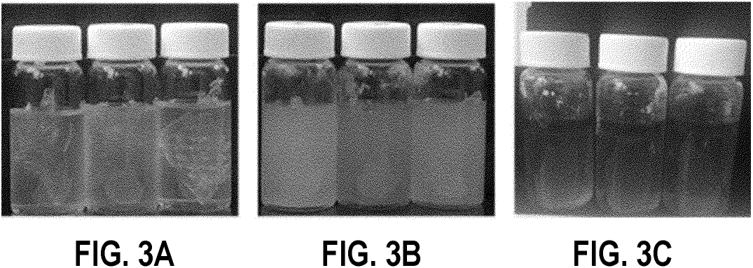

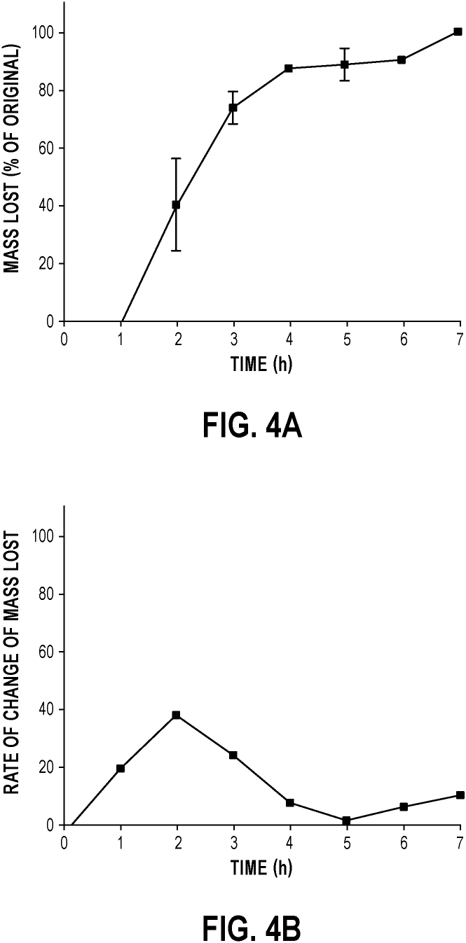

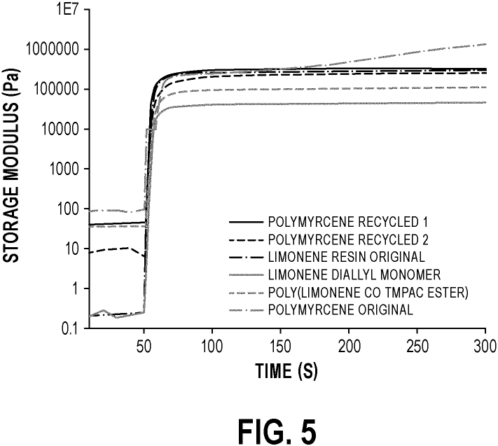

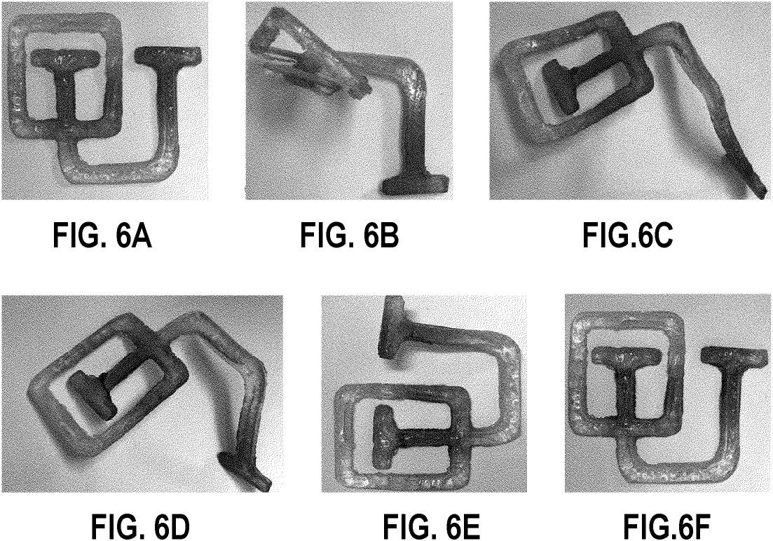

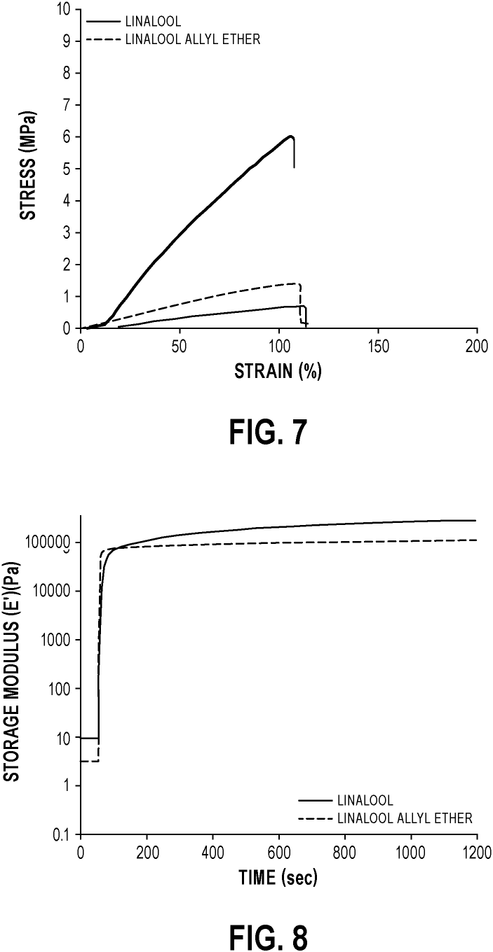

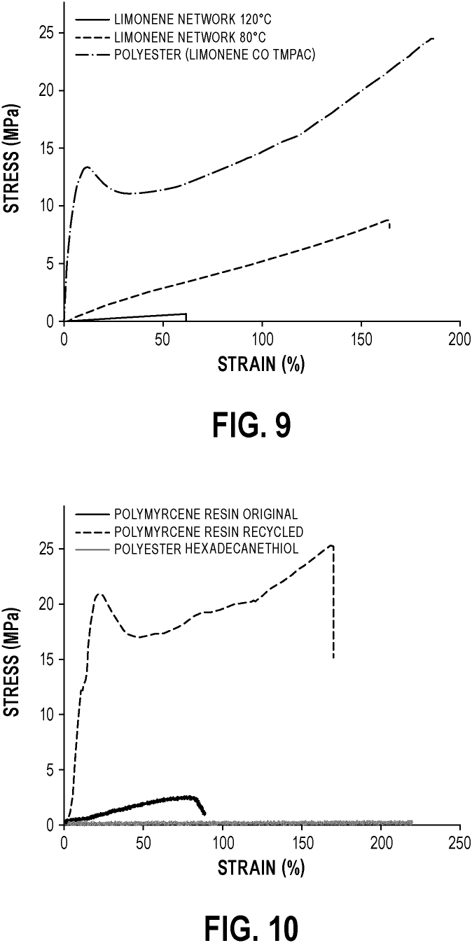

FIGS. 2A-2C show recycled Resin-PS Nanocomposites, while FIG. 3 shows a spectroscopic analysis of solubilizing crosslinkers myrcene and polymyrcene as well as the recycled polymyrcene and PS solution.

An important feature of this system is that ability to recover the PS reinforcement from the nanocomposite. As the polymer matrix is hydrolysable, the dicarboxylic acid monomers (in the case limonene) will be produced along with pentaerythritol. In the aqueous environments used for hydrolysis (10 M NaOH in H₂O or EtOH), the pentaerythritol is solubilized in the H2O, and the PS/dicarboxylic acid monomers may be extracted using organic solvents. Removal of the organic solvent allows for isolation of the PS as a solid material, as PS isn’t soluble in the limonene dicarboxylic acid monomer.

Upcycling of this limonene system can be performed separate from the PS system at this stage. This carboxylic acid monomers may be used to produce various linear polymers, such as semi-crystalline polyesters and those possessing pendant allyl groups for functionalization. Alternatively, these monomers may be used for initiating and controlling the composition in ROCOP-derived polyesters.

Finally, these monomers may be used to produce nanocomposite PS materials through simple esterifications with allyl bromide to produce allyl-ester containing limonone derivatives, which will solubilize PS. In this manner, PS may be selectively incorporated or isolated/recovered without impacting its molecular weight or properties, thereby providing a cheap, efficient method of upcycling into higher value 3D printing resins.

Other important features of this system include enhancement of shape memory, where the PS is capable of adding a rigid polymer capable of “freezing” the polymer network in a secondary, temporary shape. This shape memory is likely due to the mobility of the PS and its melting temperature.

Designing natural product-derivatives for upcycling PS does broaden the utility of the thermoset polymers slightly, as demonstrated by mechanical and rheological testing. For example, linalool allyl ether displays a higher ultimate strength and toughness compared with linalool derived resins, and recycle PM displays ultimate tensile strength of an order of magnitude greater than virgin PM, in addition to nearly doubling tensile strain to failure.

### Example 2: Ring Opening Copolymerization (ROCOP) to Produce 4D Printable Shape Memory Polyesters

### A. Materials and Methods

All chemicals were purchased from VWR International and used without purification unless otherwise stated.

1. Synthesis of polyester. ROCOP was performed based upon established literature protocols using stannous octoate and heat in sealed vials. The synthesis was performed at both small (approximately 1 g) and large (approximately 200 g) scale, with variation in the mass of the reagents but not the reaction stochiometry. Variation in polymer structure were achieved by using functionalized anhydride monomers (with mercaptopropanoic acid “clicked” onto the cyclohexene moiety prior to ROCOP) to produce alternating copolymers, as well as functionalization of oligomeric polyester to produce triblock copolymers.

2. Small scale synthesis. Cyclohexene dicarboxylic anhydride and glycidol allyl epoxide were added to a sealed vial at room temperature, along with stannous octoate. The vial was heated in an oil bath to 150° C. and allowed to stir for 48 h before cooling to room temperature. The viscous oil was collected and analyzed by NMR (shown in FIGS. 18A and 18B)

3. Photocrosslinking and 3D Printing of Polymer Resins. Photocrosslinking of resins was measured using ¹H NMR in CDCl₃. A vial of polyester, PETMP, and photoinitiator (1:1:0.05 alkene:thiol:photoinitiator) was diluted with 3 mL of CDCl₃ and separated into NMR tubes. As a unit, the tubes were irradiated with 25 W405 nm light, with tubes removed at distinct intervals and analyzed. The same ratios were used for polymer resins, which were photocured using 405 nm light (10 W) for 10 s per slice. Unlike other resins, these materials display an inherent red color (measured via UV-vis, 200 to 800 nm with a 2 nm slit) the negates the need for additional photoinhibition.

4. Thermomechanical characterization. Thermal and rheological analysis was performed using a DWS Rheolab optical rheometer (LS Instruments, Fribourg, Switzerland). Solid and liquid samples were placed in the 10 mm vial and were thermally equilibrated across a temperature range from 0 to 100° C. in 5° C. increments. Thermal transitions were determined from storage modulus and tan δ, based upon previous work comparing different behaviors in crosslinked polymer networks.

Uniaxial tensile testing to failure was conducted using an Instron with a 100 kg load cell. The printed dogbone samples (modified ASTM Type IV) were placed in the grips and pulled at 5 mm × min⁻¹ until failure, with a minimum of 5 samples per composition tested. For select compositions, the temperature was varied using a customized heating cell which allowed for sample incubation during testing, where samples were heated to the desired temperature, held isothermally for 5 min, and then tested at the previously described rate.

Cyclic testing to failure was conducted using two different methods: uniaxial tension and tension/compression. In both modalities, the same 3D printed dogbones were used. For cyclic tension, samples were deformed to 15% strain and allowed to relax to 5% strain before being strained again. Samples were cycled between these strains at 5 mm × min⁻¹, and the role of temperature was examined by testing at 20° C. and 65° C., selected by their distance from the material T_{g}. Tension/compression studies were performed by extending the samples to 10% strain, followed by compression to 10% (-10% tensile strain) at 5 mm × min⁻¹.

5. Shape memory behavior of polyesters. Shape memory behavior was characterized both with 3D printed dogbones as well as by using the porous printed structures. For dogbones, samples were placed in the tensile clamps and heated to 50° C., after which the samples were allowed to thermally equilibrate for 5 minutes. Samples were then uniaxially stretched to 22.5% strain at variable rates, at which point the samples were cooled to 0° C. using a customized apparatus. The tensile load was released and the grips were returned together at the same rate as the deformation. Comparisons of the rate of deformation were used to determine the rate of recovery.

For porous polyester cubes, samples were heated to 75° C., crushed and then folded to reduce overall volume by 30 times. The deformation was mechanically held for 30 min, allowing the sample to equilibrate to room temperature. The mechanical load was removed and the sample analyzed for strain fixation based upon approximate change in volume. Shape recovery was initiated by heating the sample to 50° C., with images taken over the course of the recovery period.

### B. Results and Discussion

The ROCOP of the cyclohexene anhydride and the glycidol allyl ether (Scheme 1) resulted in polyester copolymers with molecular weights ranging from 1.0 kDa to 250 kDa, or in other embodiments from 16.0 kDa to 23.7 kDa (Mₙ), as determined by NMR. End group analysis revealed the presence of both carboxylic acid and alcoholic endgroups, as well as continued the presence of both the allyl and the cyclohexene functional groups within the polymer chain, which could be leveraged for further reactions. ROCOP was further leveraged to produce triblock copolymers with additional functional groups to achieve multifunctional materials. Thiol-ene click reactions were used to react the alkene moieties of both cyclic monomers with mercaptopropanoic acid, producing cyclic monomers with carboxylic acid side chains. The polyester copolymers formed are shown below:

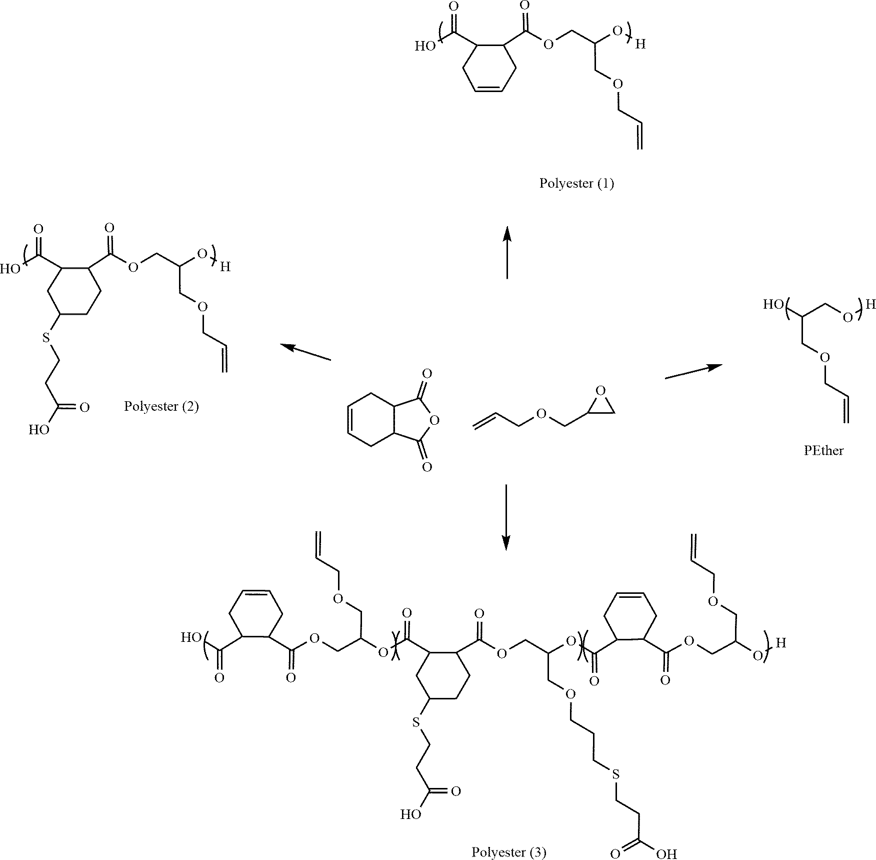

A synthetic scheme for producing triblock polyester copolymers is shown below:

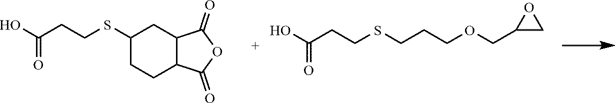

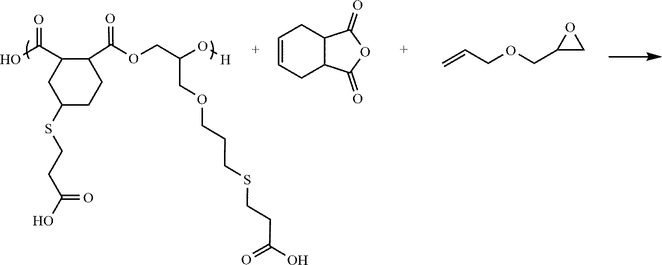

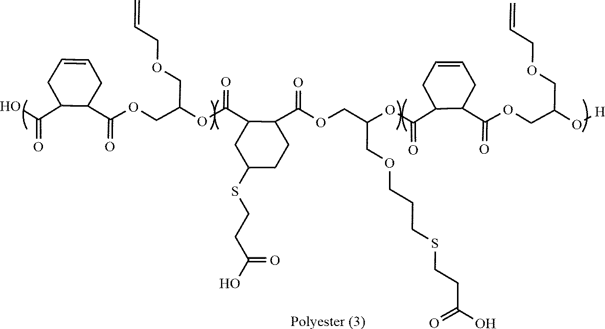

The polymers displayed shear thinning behavior overall, indicative of the entanglements between polymer chains not becoming aligned over the examined frequency range. This is most likely due to the allyl ether side chains, which are flexible and long enough to interact with each other as well as with the main polymer backbones. The polymer backbone will also be rigid due to the cyclohexene moiety and interactions of the carbonyls, further preventing entanglement.

The polyester was a dark red, with a UV-vis absorption relative maxima at λ = 455 nm which a FWHM of approximately 20 nm, indicating that it could find use a photoinhibition agent as well as the polymer within the resin for blue and purple light based DLP and SLA techniques. UV-vis of commercially available photoinitiators was also conducted to assess suitable materials for incorporation and compatibility with the polyester resin (including PETMP as the thiol component), indicating while several could be used, Irgacure 819 is the best candidate. With a stronger absorbance in the 405 nm region, photoinitiation would be favored, yet some competition with the absorbance due to the polyester would result in better resolution in the DLP-printed surface.

Photoinduced crosslinking in the presence of the 4-armed thiol PETMP was examined over the course of 45 s (5% photoinitiator and 20 mW405 nm light), over which time the solutions for ¹H NMR analysis had sufficiently gelled into solid form. Qualitatively, the polyesters and PETMP would gel within 5 of exposure to a 25 W 405 nm light source in CDCl₃. This is fast enough that a droplet of polymer resin would solidify without dropping when allowed to run off the tip of a microscope slide. Quantitatively, by 45 s approximately 70% of the alkenes have been consumed. Initially the allyl groups are consumed more rapidly, however with extended curing (greater than 30 s), the alkenes are consumed similar amounts. This indicates that for DLP printing, crosslinked parts will have equally cured cyclohexene and allyl moieties, but that there will likely be residual surface groups that could be leveraged if desired.

The rheological behavior of the polymers was determined using optical rheometry of both the synthesized polymers and the resins. The initial resin viscosity is ~1 Pa*s, typical for photopolymerization resins, indicating that upon printing the liquid will be able to flow into voids left by solid part removal yet retain enough viscosity to form the solid parts needed, unlike other resins that have demonstrated very low initial viscosities which require additional processing prior to use. The resins, despite having a lower viscosity, were found to be reactive within seconds.

A synthetic scheme for ring opening copolymerization of the polyester is shown below:

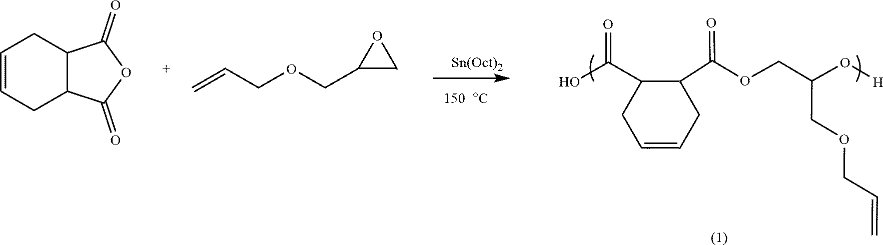 [SMILES: O=C(CCS)OCC(COC(=O)CCS)(COC(=O)CCS)COC(=O)CCS]

The ring-opened copolymer shown immediately above may be combined with a 4-arm thiol, such as PETMP, and a photoinitiator, such as Irgacure 819, to produce a red resin. The structures for PETMP and Irgacure 819 are shown below:

[symbol]

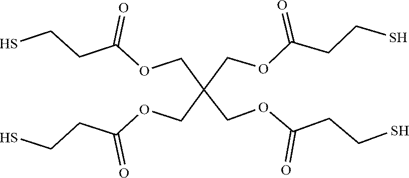

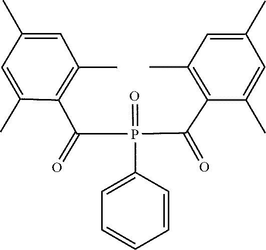

An alternative scheme for ring opening copolymerization of the polyester is shown below:

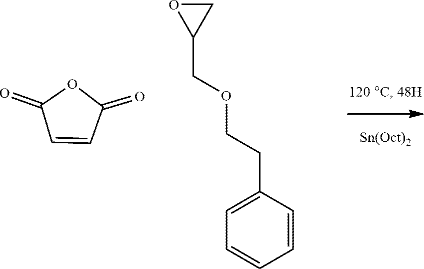

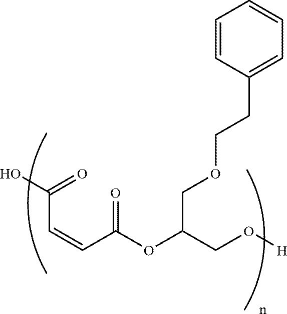

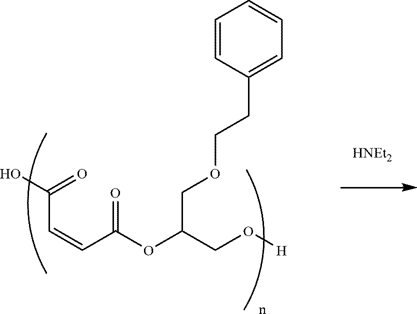

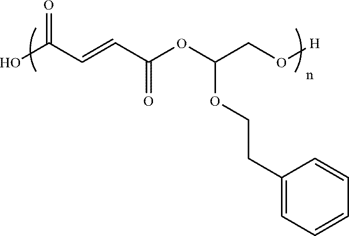

The scheme shown immediately above shows synthesis of poly(maleate co phenol glycidol ether) through the ring opening copolymerization of malic anhydride and phenol glycidol ether followed by the isomerization into poly(fumarate co phenol glycidol ether).

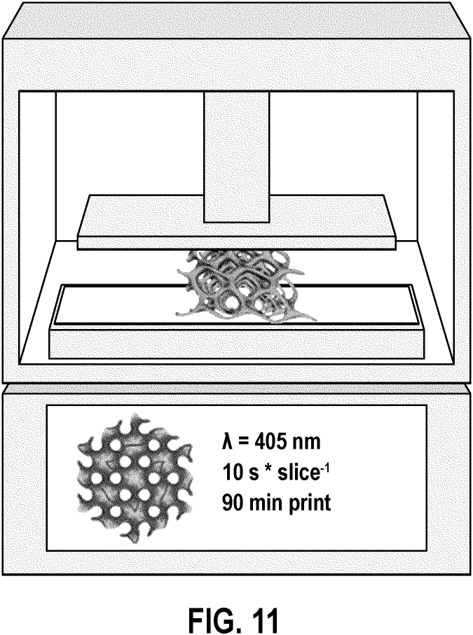

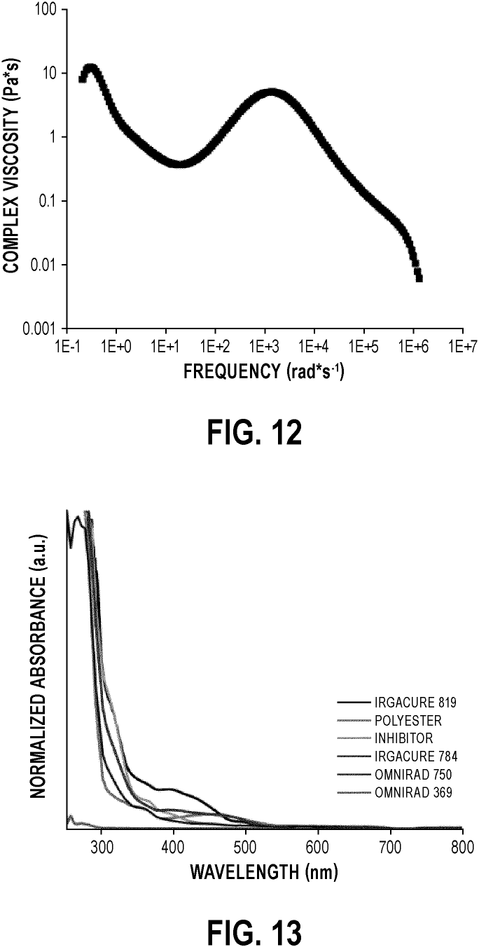

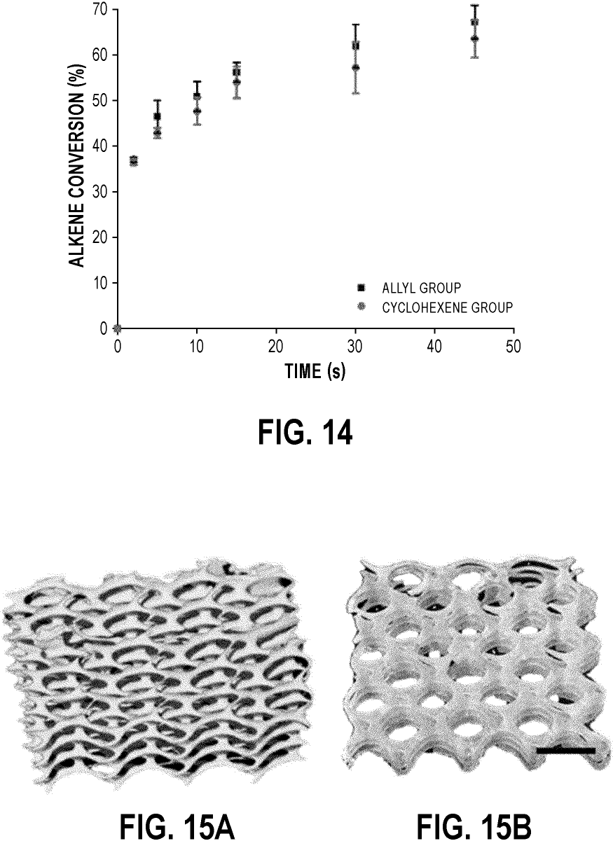

FIG. 11 shows the DLP-type 3D printing to produce porous cubes. FIG. 12 shows the viscosity behavior of the polyester-derived resin. FIG. 13 shows the UV-vis spectra for selected photoinitiators and the polyester demonstrating its function as a photoinhibiting agent. FIG. 14 shows conversion of the cyclohexene alkene compared with the allyl alkene as measured by ¹H NMR for 1:1:0.05 (alkene:thiol:photoinitiator) samples in CDCl₃. FIG. 15A shows a representative image of the printed porous structures, displaying a reassembled structure imaged using micro CT. FIG. 15B shows a representative image of the printed porous structures, displaying a optical microscopy of a similar printed structure.

The polyester resins were then processed using DLP into dogbones and solid films for thermomechanical analysis. The glass transition temperature (T_{g}) of the polyester copolymers was found to be 67.2 ± 0.7° C., with the triblock copolymers and functionalized copolymer displaying T_{g}s well below room temperature. Uniaxial tensile strain to failure testing further demonstrated the limited utility of these other materials relative to the polyester copolymer. Specifically, the strains at break of the triblock and functionalized polyester were below the average of the unfunctionalized polyester copolymer, as were the elastic modulus, ultimate tensile strain, and toughness. The triblock polyester with polyether end blocks displayed superior strain at break (approximately 160%) however these materials were still brittle when handled, limiting their physical utility as well as processability for DLP-type printing.

Ultimately, the unfunctionalized polyester copolymer was selected for further analysis, as the combination of the high T_{g} and robust mechanical properties indicated it would be a suitable candidate for repeated use. To test these, cyclic tensile and cycling tension/compression testing was carried out of the polymer dogbones. At room temperature (glassy network), the polyester could undergo nearly 400 cycles prior to complete fracture, with more than 200 possible prior to any fracture. At the Tg, the polyester could withstand more than 100 cycles prior to fracture, with the expanded network volume attributed to the increased brittleness. The energy absorption, resilience, and energy return of the polyester was found to be dramatically reduced after the initial cycle, most likely due to network settling as well as macroscopic settling of the dogbone samples. This behavior also was found for temperatures up to 55° C., although the elastic moduli of the samples was found to be relatively stable by 45° C. This analysis indicates that the network begins relaxation at approximately

DLP 3D printing was used to produce solid parts within seconds of exposure, with monolithic structures (surface area greater than ~3 mm²) requiring 5 s exposure to gel and smaller features requiring ~10 s to solidify sufficiently to support themselves. A 3D porous cube was printed using DLP-type 3D printing, with 5 s per slice (after a 60 s burn in of 4 base layers) using 1 W 405 nm light. The resulting structure was evaluated using microCT scanning as well as optical microscopy (Keyence light microscope). These images revealed a repeatable porous structure (with resolutions of 50 µm in the Z-direction per step) which displayed shape memory behavior. The porous structure allowed for greater changes in the volume expansion of the shape memory, with up to 70x volume expansion found. This is similar to the reported values for shape memory polymer foams, which do not allow for the same control over surface features or reproducibility of pores.

The photocrosslinked films displayed shape memory behavior. The polyester backbone’s cyclohexene moiety is rigid and allows for the temporary secondary shape to be fixed due to the reduced backbone flexibility, similar to vinyl polymer backbones. Typically, polyesters display shape memory secondary shape is due to crystalline domain formation, while other species such as polyurethanes or polyamides display temporary shape in part due to hydrogen bonding. A photocrosslinked polymer was fabricated into a net-like structure to test the flexibility and shape memory of printed materials.

While the triblock and functionalized polyesters are capable of withstanding multiple extension cycles and recovering in a similar manner as the polyester copolymer, their behavior is elastic. The polyester copolymer displays shape memory due to the rigidity of the polymer backbone; whereas the triblock polyesters are more flexible due to the polyether segments and the decreased crosslink density, the polyester copolymer is a more rigid glassy network up to ~40° C. (determined mechanically, which is a reasonable approximation as demonstrated by Steelman et al).¹ The glassy nature of the polymer allows for shape memory behavior even though there are no typical moieties to induce strain fixation such as crystalline domains or hydrogen bonding moieties. Seemingly the shape memory behavior shown here is attributable solely to the network rigidity.

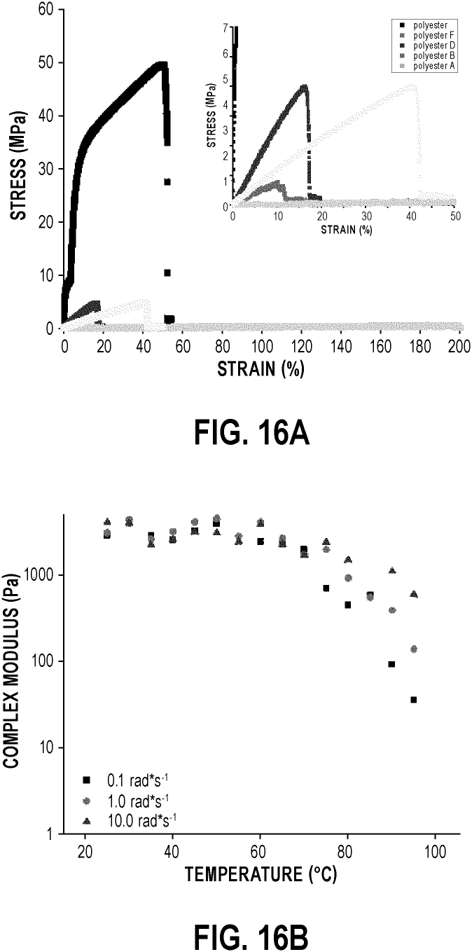

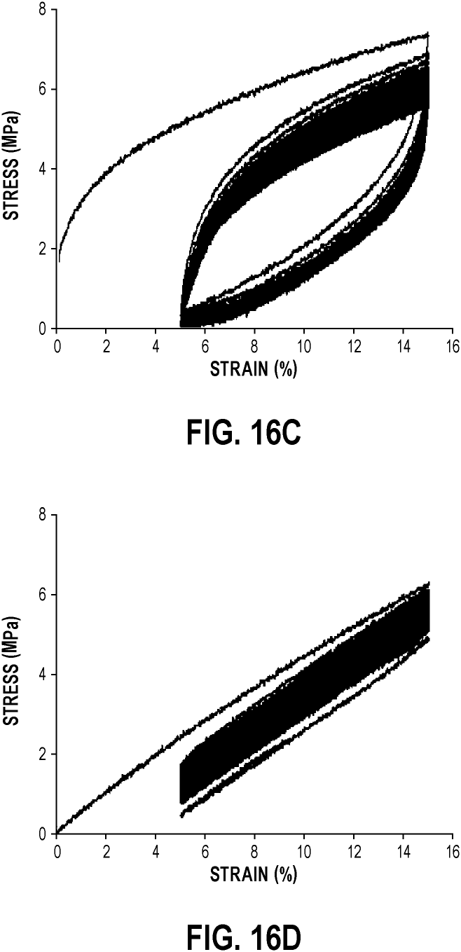

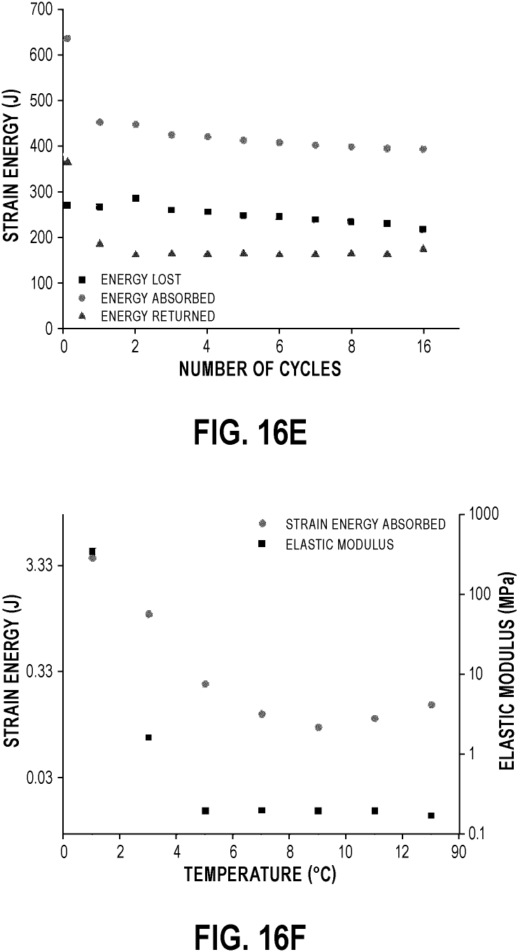

FIGS. 16A-16F show data collected for dogbones 3D printed using the resin described herein. FIG. 16A is a graph representing uniaxial tensile curves to failure for modified ASTM Type IV dogbones tested at 5 mm × min⁻¹ at 25° C. under ambient atmosphere. FIG. 16B is a graph showing thermal analysis of the complex moduli of the polyester film as determined by shear rates across three orders of magnitude. FIG. 16C is a graph showing cyclic tensile testing of polyester copolymer films tested at 5 mm × min⁻¹ at 25° C. under ambient atmosphere for 100 cycles. FIG. 16D is a graph showing cyclic tensile testing of polyester copolymer films tested at 5 mm × min⁻¹ at 65° C. under ambient atmosphere for 100 cycles. FIG. 16E is a graph showing energy absorbed, returned, and lost for polyester copolymer films as a function of cycle. FIG. 16F is a graph showing the energy lost/elastic moduli for polyester copolymer films as a function of temperature for samples tested cyclic tensile testing of polyester copolymer films tested at 5 mm min⁻¹ under ambient atmosphere at cycle 2.

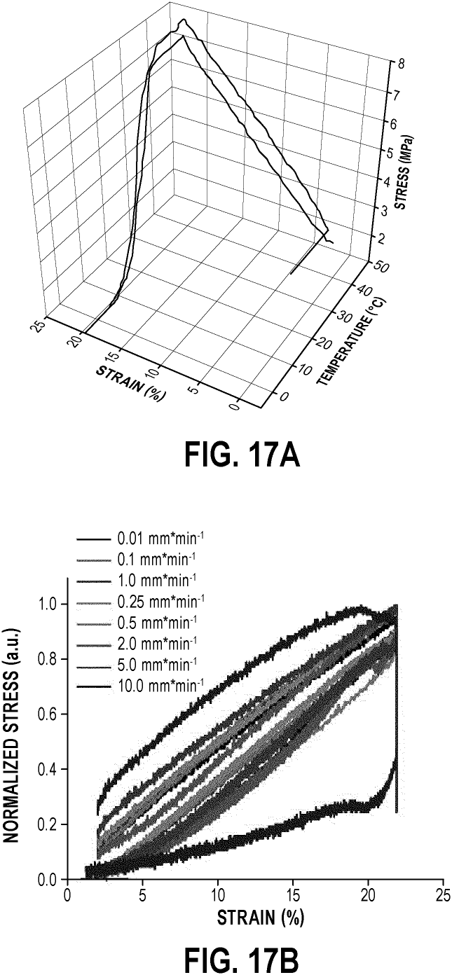

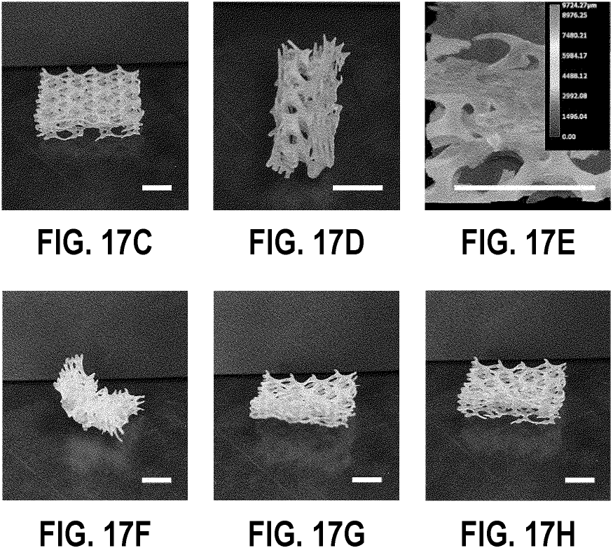

FIGS. 17A-17H show graphs and images of the shape recovery properties of items or apparatuses 3D printed using the resin described herein. FIG. 17A is a representative quantified shape recovery of polyester copolymer films tested using thermal sweeps and uniaxial cyclic testing at cycle 2. FIG. 17B is a graph showing corresponding representative strain recovery sweeps varying the recovery rate from 0.01 mm x min⁻¹ to 10 mm x min⁻¹ at 50° C., ambient atmosphere. FIG. 17C is an image of an original printed porous structure. FIG. 17D is an image of a deformed structure. FIG. 17E is a topographical image of a strut reorientation during a strain fixation. FIG. 17F is an image showing shape memory behavior of a printed porous structure 5 seconds after fixation. FIG. 17G is an image showing shape memory behavior of a printed porous structure 10 seconds after fixation. FIG. 17H is an image showing shape memory behavior of a printed porous structure 20 seconds after fixation.

As explained above, ROCOP was used to produce linear polyesters from epoxides and cyclic anhydrides, with reactive allyl and cyclohexene functionalities which may be used to produce crosslinked networks. Thiol-ene click chemistry crosslinking was found to occur rapidly enough to support DLP-type 3D printing of the photopolymer formulations, and was used to produce 3D porous structure prototypes and dogbones for mechanical analysis. Variations in the polymers and the crosslinking density could be used to vary the mechanical behavior of the polymer, with the Polyester formulation displaying the greatest mechanical stability, as well as shape memory due to its higher-than-room temperature T_{g} and glassy network. In fact, the high rigidity of the network on a macroscopic scale is hypothesized to be the result of some of the fracturing found during shape memory testing, however the crosslinked network is robust enough to maintain and stabilize its shape even with multiple fractures of the 3D monolithic structure, indicating the promise of these materials in 3D printing for a variety of biomedical and other applications.

### Depolymerization and Value Addition

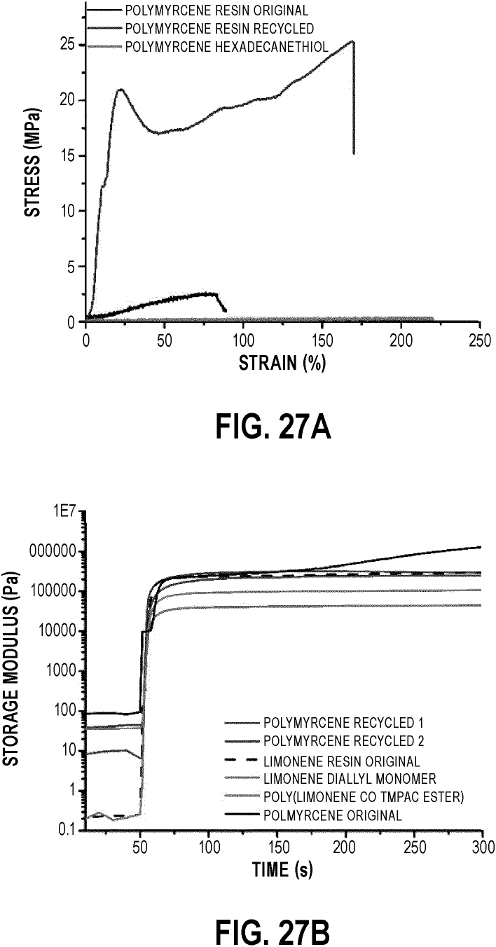

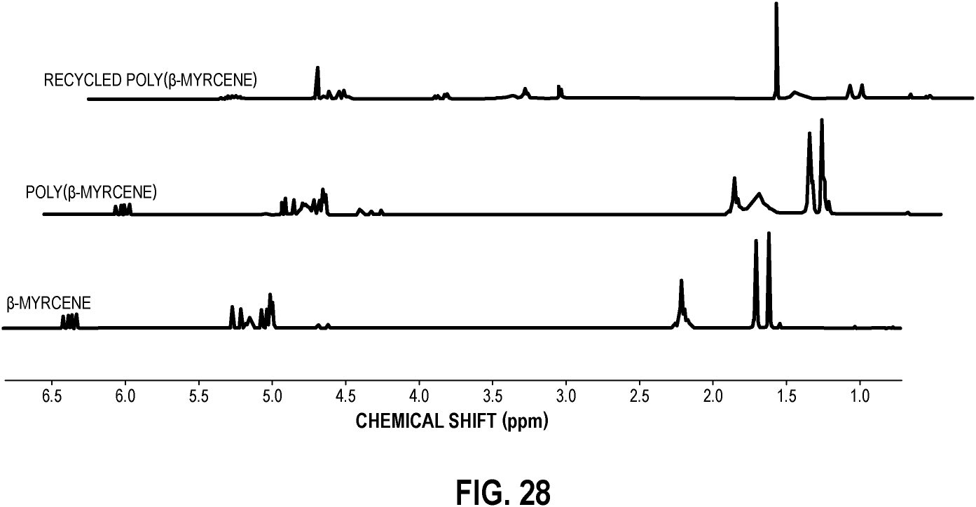

Depolymerization of the photopolymerized films in the presence of select monomers and organobase catalysts allows for their recycling and even upcycling or collection and further reuse of the incorporated polystyrene compositing material. Preliminary results indicate that the limonene-thiol films can be depolymerized in the presence of DBU and a variety of different alcohols (including natural products such as linalool) and amines, with allylamine displaying the most rapid (qualitatively) depolymerization. The resultant polymers and reactive monomers may then be subsequently used for photopolymerizations and 3D printing processes without limitation (FIG. 27B displays photorheology). In poly(limonene-co-myrcene) thermosets, the depolymerization is significantly slower, although complete dissolution of the thermosets in the presence of DBU was found to occur after 3-5 days at 120° C. in the presence of either allylamine or propargyl alcohol. Other important preliminary studies include upcycling of poly(P-myrcene) where upon hydrolysis in 5 M NaOH, the poly(P-myrcene) may be recovered and immediately repolymerized using photocrosslinking into a solid film after mixing with the required photoinitiator and thiol, which displays orders of magnitude improved mechanical strength without a loss of gelation rate determined rheologically. This has been demonstrated to be feasible with and without the presence of the polystyrene additive.

The recovered products, which include monomers and polymers containing varied reactive moieties necessary for photopolymerization 3D printing (allyl-, epoxide-, acrylate-, methacrylate-, alkyne-, etc) may also be used to dissolve virgin or recycled polystyrene. The composite resins and inks may then be used for 3D printing processes including stereolithography, digital light processing, CLIP, HARP, and direct ink writing/robocasting techniques. These materials are also suitable for more mainstream manufacturing, including casting, machining, and foaming amongst others.

### Leveraging Stereochemistry and 3D Printable Resin Off-Stoichiometry in Aliphatic Polyesters Made By Ring Opening Copolymerization to Tailor Material Properties

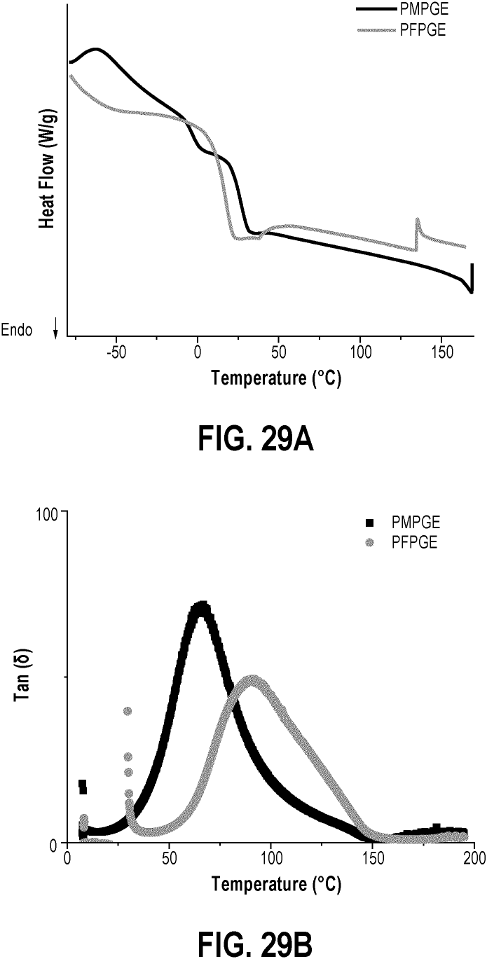

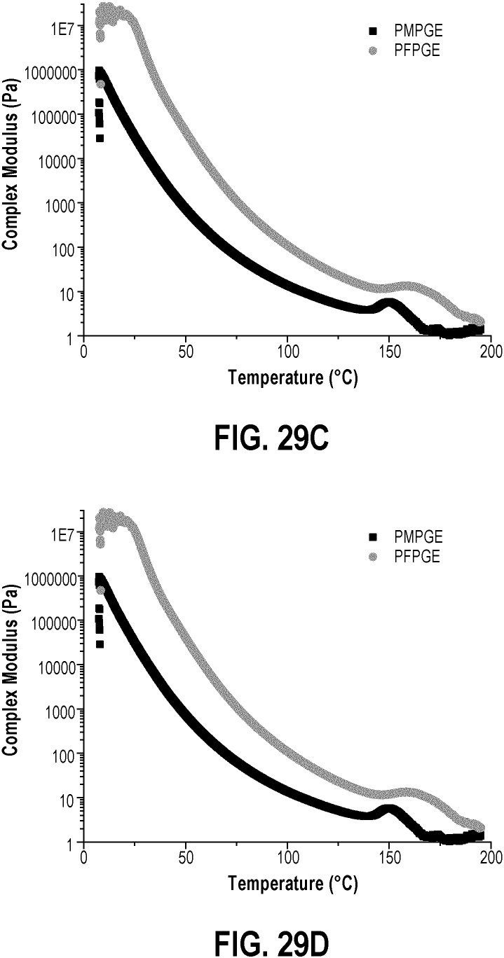

As shown in FIGS. 29A-D, rheological characterization was run on the cis and trans states of the polyester using a standard temperature and flow sweep. The oscillatory temperature sweep was conducted at an angular frequency of 10.0 rad × s⁻¹, beginning at 5° C. and heating to 195° C. at a rate of 2° C. × min⁻¹ (FIGS. 29B,C, and D), the frequency sweep was conducted at a strain of 0.02 at 25° C. performed from 0.1 to 100 radians × sec⁻¹, and the flow sweep was performed by stepping the uni-rotational shear rate from 0.2 to 2000.0 s⁻¹ at 25° C. for 20 step increments (FIG. 29D).

It is noted that (1) PFPGE displays higher viscosity than PMPGE from flow and temp sweep, (2) tan delta from the temp sweep shows a higher Tg from PFPGE than the PMPGE indicating a more crystalline structure most likely due to the trans stereochemical state allowing for better chain packing than the cis state, (3) the PFPGE holds higher modulus and viscosity values as the temperature increases until the temperature reaches 195° C. where both copolymers are likely experiencing a melt; and (4) losing any viscoelastic properties.

GPC was run using an Agilent series 1100 HPLC calibrated using polystyrene standards and CHCl₃ as the solvent on the cis and trans states of the polyester determining molecular weight and dispersity of the copolymers. The isomerization changed the Mw within the expected error of 10% and the T_{g} and through differential scanning calorimetry using a TA instruments DSC Q2000. A temperature sweet was performed on the copolymers stepping from -90° C. to 170° C. in an increment of 10° C. per minute. The results are shown in TABLE 1 below:

TABLE 1

| Formulation | Mw (kDa) | Ðm | T_{g}(°C) DSC | T_{g} (°C) Rheology |
|---|---|---|---|---|
| PMPGE | 9.16 | | -2.80 | 66.9 |
| PFPGE | 10.5 | | 17.4 | 92.2 |

It is noted that:
Initial characterization of thermoplastics
The molecular weights of PMcoPGE and PFcoPGE are within 10% of each other, consistent with literature (cite Coates article)
Tg increases with isomerization, consistent with isomerization (Connor and Dove paper, also probably a Becker)

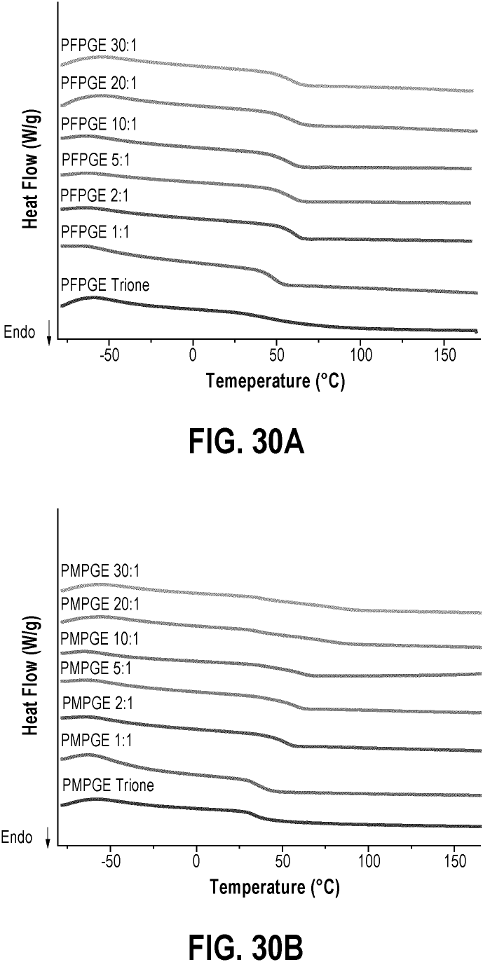

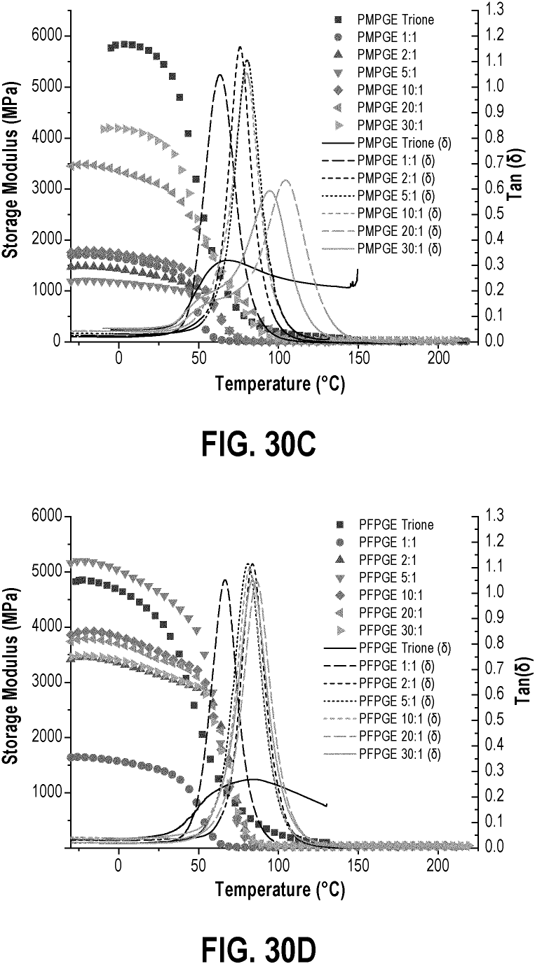

FIGS. 30A-D are T_{g} comparisons of PMPGE and PFPGE with increasing photopolymer resin off-stoichiometric ratio. The samples were run via DSC (A and B) on a temperature sweep ranging from -90° C. to 170° C. at a rate of 10° C./min and DMA (C and D) on a temperature sweep ranging from -30° C. to 220° C. at a constant load of 0.01 N and a frequency of 10 Hz.

TABLE 2, below, shows, T_{g} comparison of PMPGE and PFPGE films across DSC and DMA testing along with storage and loss modulus values in and around the T_{g} of both isometric states of the photopolymer films. All formulations of PMPGE and PFPGE were made using stoichiometric amounts of trione in relation to the copolymer.

TABLE 2

| Formulation | Tg (°C) DSC | Tg (°C) DMA | E′ 20° C. Below T_{g} (MPa) | E′ at T_{g} (MPa) | E′ 20° C. Above T_{g} (MPa) | E″ 20° C. Below T_{g} (MPa) | E″ at T_{g} (MPa) | E″ 20° C. Above T_{g} (MPa) |
|---|---|---|---|---|---|---|---|---|
| PMPGE-T | 33.5±0.80 | 65.5±2.33 | 3493±27 4 | 1034±11 3 | 271±36.7 | 605±96.1 | 331±36. 8 | 90.8±8.1 2 |
| PMPGE 1:1 | 47.7±2.65 | 65.6±2.2 | 1014±97. 3 | 41.9±3.9 | 9.27±0.7 | 167±33.3 | 43.6±2.5 | 1.45±0.2 |
| PMPGE 2:1 | 54.8±0.07 | 74.5±1.49 | 1112±18 3 | 44.8±6.1 6 | 10.9±2.5 8 | 123±8.07 | 51.9±6.7 7 | 3.72±2.8 9 |
| PMPGE 5:1 | 60.8±0.45 | 80.7±1.27 | 827±250 | 40.9±15. 9 | 9.80±4.1 5 | 146±46.4 | 43.7±15. 4 | 1.43±0.6 5 |
| PMPGE 10:1 | 58.8±0.29 | 79.6±0.85 | 678±24.5 | 32.1±1.0 1 | 5.20±4.5 2 | 160±14.7 | 33.8±0.8 2 | 1.33±1.4 4 |
| PMPGE 20:1 | 74.44±2.4 8 | 104±0.26 | 600±39.6 | 79.0±4.6 2 | 23.8±1.8 4 | 175±19.8 | 51.1±4.2 8 | 4.81±0.4 9 |
| PMPGE 30:1 | 81.0±1.43 | 100±6.73 | 692±72.8 | 93.7±8.3 2 | 29.9±7.4 3 | 199±26.2 | 55.4±8.1 1 | 8.65±6.6 3 |
| PFPGE-T | 46.6±0.46 | 85.8±2.35 | 1394±30 9 | 548±102 | 238±39.9 | 347±73.9 | 156±31. 1 | 57.9±12. 5 |
| PFPGE 1:1 | 49.6±0.96 | 70.8±3.67 | 994±257 | 44.9±8.3 6 | 10.0±0.8 0 | 118±11.5 | 49.1±9.1 9 | 1.16±0.1 9 |
| PFPGE 2:1 | 58.8±0.51 | 81.8±1.78 | 2676±49 3 | 135±15. 8 | 32.3±2.1 0 | 313±72.3 | 152±18. 3 | 4.49±1.1 5 |
| PFPGE 5:1 | 57.1±0.31 | 80.4±0.63 | 2359±17 0 | 121±4.6 8 | 29.9±1.4 1 | 393±31.8 | 134±5.6 0 | 4.51±0.6 4 |
| PFPGE 10:1 | 53.9±0.09 | 78.8±6.09 | 2293±39 6 | 118±6.4 2 | 28.6±3.8 7 | 358±53.3 | 128±8.2 7 | 5.77±2.1 0 |
| PFPGE 20:1 | 59.3±0.71 | 85.1±1.07 | 2039±25 7 | 119±8.6 7 | 28.5±2.5 5 | 385±28.6 | 125±10. 5 | 4.42±0.3 7 |
| PFPGE 30:1 | 59.7±0.59 | 83.3±0.64 | 2090±37 1 | 136±2.6 9 | 33.9±0.2 3 | 405±25.8 | 143±2.1 6 | 6.26±0.4 6 |

It is noted that: (1) there is a slight shift in the T_{g}’s from the isomerization but probably not significant; (2) there is a distinct increase in the T_{g}’s going from 1:1 and Trione to 2:1 and the upper ratios; (3) there is a dramatic increase in the storage and loss moduli due to the isomerization from PMPGE to PFPGE; and (4) there is a gradual increase in the T_{g}’s as the off-stoichiometric ratios increase in the PMPGE and the PFPGE.

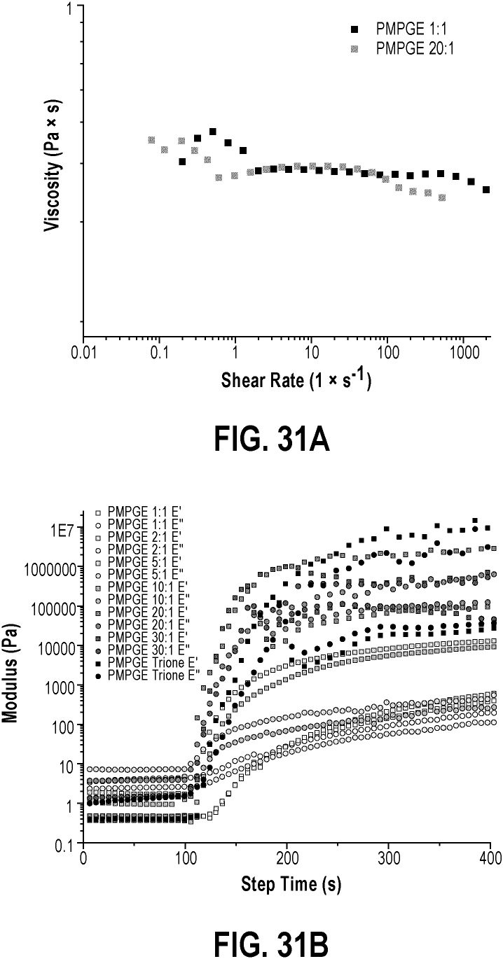

FIGS. 31A-B shows graphs of a rheological comparison of photopolymer resins using a standard flow sweep by stepping the uni-rotational shear rate from 0.2 to 2000.0 s⁻¹ at 25° C. for 20 step increments stoichiometrically balanced resins up to a 30:1 off stoichiometric ratio using PMPGE (A) and PFPGE (B). Photocrosslinking comparison of PMPGE photopolymer resins ranging from stoichiometrically balanced between the thiol and alkene components (1:1) to stoichiometrically balanced between the copolymer and trione of both the PMPGE (C) and the PFPGE (D). All formulations were performed with 2 wt% of photoinitiator.

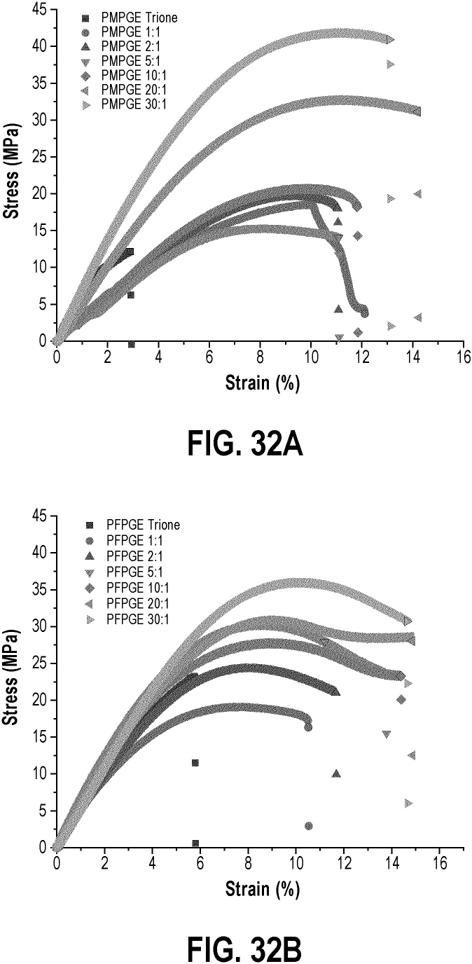

FIGS. 32A-B show graphs of tensile testing of photopolymer resin dog bones with a cross sectional area measuring 1.5 mm × 4.0 mm × 10 mm. All formulations are made using 25 wt% trione.

TABLE 3, below, shows a quantitative comparison of resultant tensile testing mechanical values of PMPGE and PFPGE photopolymer resins with increasing off-stoichiometric ratios.

TABLE 3

| Formulation | Elastic Modulus (MPa) | Ultimate Strength (MPa) | Strain at Break (%) | Toughness (MPa) |
|---|---|---|---|---|
| PMPGE 1:1 | 401±103 | 23.1±7.98 | 12.0±2.66 | 200±83.6 |
| PMPGE 2:1 | 324±38.2 | 22.4±3.68 | 11.6±2.39 | 178±66.2 |
| PMPGE 5:1 | 355±92.9 | 19.7±3.54 | 7.09±2.27 | 76.4±27.5 |
| PMPGE 10:1 | 293±40.5 | 18.2±2.82 | 12.6±1.94 | 159±17.9 |
| PMPGE 20:1 | 490±43.2 | 30.3±2.90 | 15.2±3.13 | 345±94.7 |
| PMPGE 30:1 | 636±81.9 | 37.7±4.02 | 10.7±1.80 | 267±63.1 |
| PFPGE 1:1 | 463±91.4 | 23.8±5.05 | 14.7±2.91 | 270±84.8 |
| PFPGE 2:1 | 548±69.6 | 31.5±6.32 | 11.9±2.51 | 270±100 |
| PFPGE 5:1 | 545±45.0 | 27.8±2.83 | 12.1±2.78 | 252±91.0 |
| PFPGE 10:1 | 534±58.5 | 26.5±4.33 | 12.7±1.85 | 253±64.5 |
| PFPGE 20:1 | 536±92.3 | 28.6±3.93 | 14.5±4.04 | 308±102 |
| PFPGE 30:1 | 576±68.5 | 32.2±3.88 | 11.5±2.45 | 267±87.9 |

It is noted that (1) increase in ultimate strength, elastic modulus, and toughness of PFPGE over PMPGE; and (2) increasing strain at break and ultimate strength as the off-stoichiometric ratios increase, however the difference is not significant except for going from the 1:1 to the upper level ratios, similar to the Tg behavior illustrated from the DSC and DMA.

FIGS. 32A-D are graphs and photographs showing shape memory kinetics conducted on PMPGE 1:1, PFPGE 1:1, PMPGE 30:1, and PFPGE 30:1 photocrosslinked films. FIG. 32E are selected images from images taken every two seconds measuring the strain recovery rate of the films at every testing temperature. 37, 50, 75, 100, and 125° C. were tested for PMPGE 1:1 and PFPGE 1:1 (A) while 44, 60, 90, 120, and 150° C. were tested for PFPGE 30:1 and 63, 85, 126, 169, and 211° C. were tested for PMPGE 30:1 (B). The time at which each film reached 95% strain recovery for all formulations was quantified at the temperatures previously stated (C). Strain fixation was tested on the films over a twelve-hour period time window in room temperature (D). (E) shows the progression of PMPGE 1:1 undergoing 100% strain recovery at 50° C.

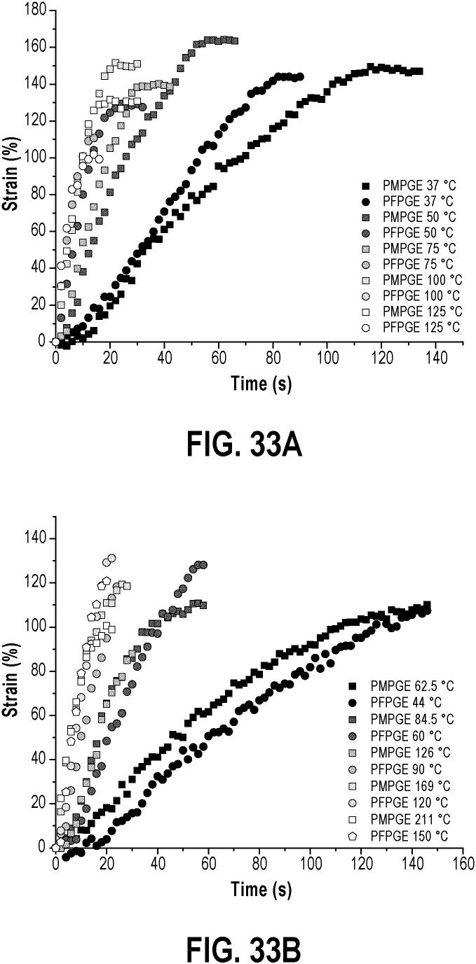

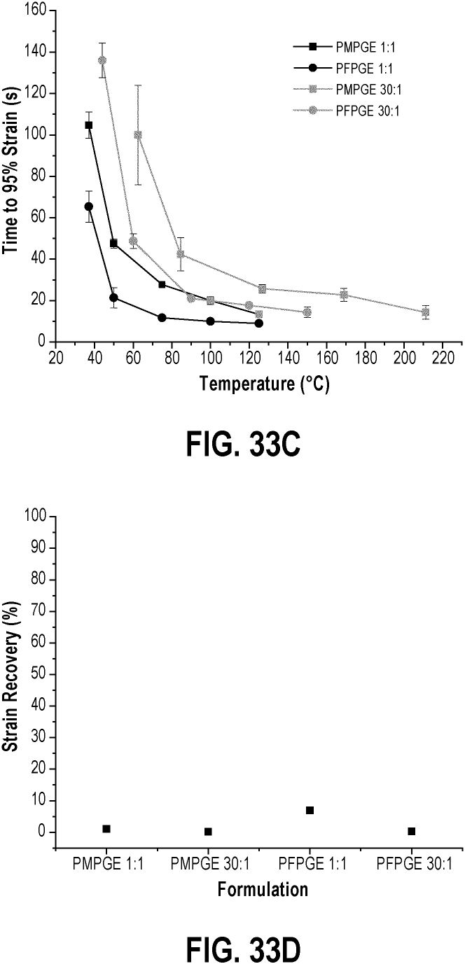

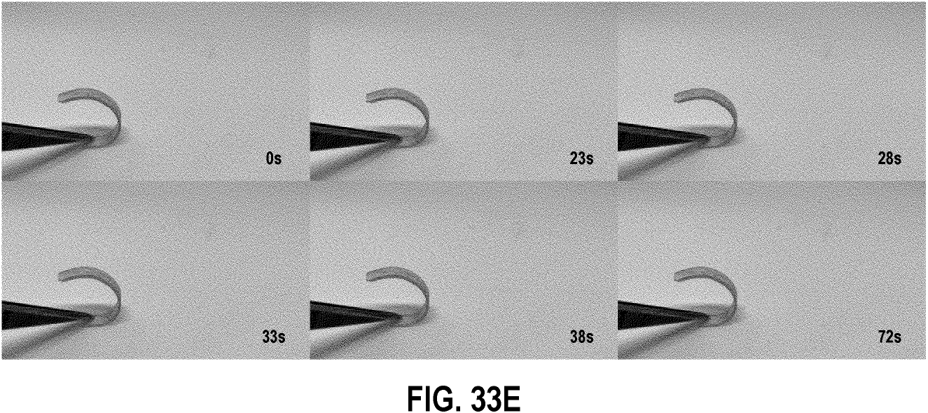

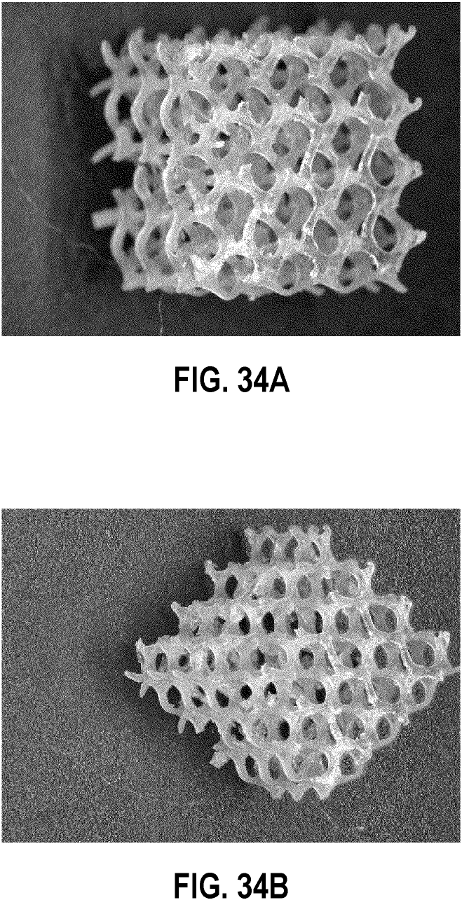

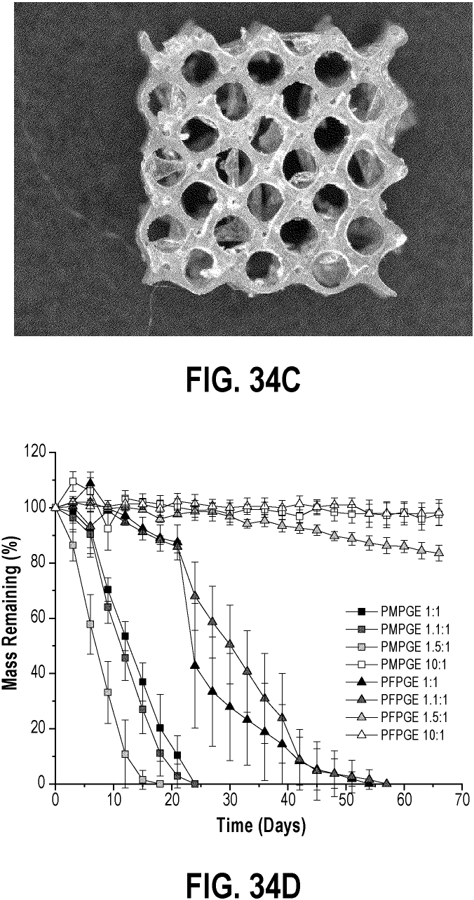

FIGS. 33A-C are keyence microscope images of 3D printed scaffolds of PFPGE 1:1 via digital light processing. Shown are an isometric (FIG. 33A), oblique (FIG. 33B), and top (FIG. 33C) views of the scaffold. FIG. 33D shows a graph of an accelerated gravimetric analysis performed on the 1:1, 1.1:1, 1.5:1, and 10:1 off stoichiometric ratios of the PMPGE and PFPGE photocrosslinked films. These films were placed in 0.1 M NaOH solution and tested every three days measuring the films mass loss over time in solution.

While the present invention has been disclosed by reference to the details of preferred embodiments of the invention, it is to be understood that the disclosure is intended as an illustrative rather than in a limiting sense, as it is contemplated that modifications will readily occur to those skilled in the art, within the spirit of the invention and the scope of the amended claims.

What is claimed is:

1. A 3D printable resin comprising:
a polystyrene; and
at least one of a solubilizing crosslinker, a solubilizing polymer, a natural terpene, a natural terpenoid, or a natural polymer.

2. The 3D printable resin of claim 1, wherein the 3D printable resin comprises the solubilizing crosslinker, and the solubilizing crosslinker is selected from a group consisting of limonene, limonene di(thioether propanoic allyl ester), limonene di(thioether propanoic acid), myrcene, polymyrcene, linalool allyl ether, dilinalool IPDI, dilinalool HDI, trilinalool phosphate, eugenol, dieugenol HDI, dieugenol IPDI, and combinations thereof.

3. The 3D printable resin of claim 1, wherein the 3D printable resin comprises the solubilizing polymer, and the solubilizing polymer is selected from a group consisting of a compound having a structure of: 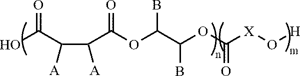
where A is a functional group selected from a group consisting of at least one of the following functional groups: 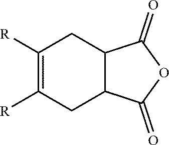 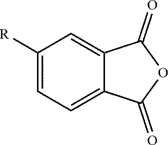 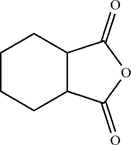 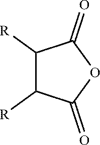 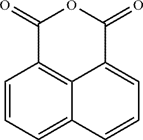 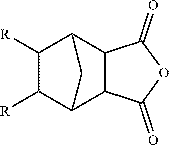 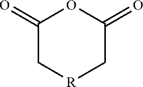 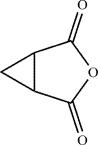
where B is a functional group selected from a group consisting of at least one of the following functional groups: 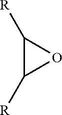 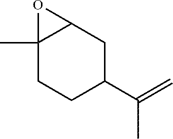 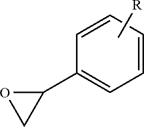 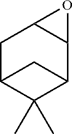 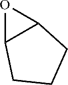 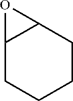 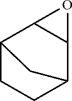 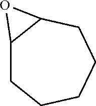 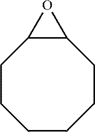 [SMILES: C=C1CCC2OC2(C)CCCC(C)(C)CC1] 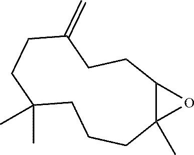
and where each R is independently a functional group comprising an aryl or alkyl, saturated or unsaturated, substituted or non-substituted, carbon chain or carbon ring.

4. The 3D printable resin of claim 1, wherein the 3D printable resin is photocurable.

5. The 3D printable resin of claim 1, wherein the 3D printable resin is active to a wavelength in a purple-blue region and a wavelength in an ultraviolet region.

6. The 3D printable resin of claim 1, wherein the at least one of the solubilizing crosslinker or the solubilizing polymer is formed via a ring opening copolymerization process.

7. The 3D printable resin of claim 1, further comprising:
a photoinitiator;
a photoinhibitor; and
a pentaerythritol tetrakis(3-mercaptopropionate).

8. A ring-opened polyester copolymer comprising:
a product of a reaction between a cyclic anhydride and an epoxide.

9. The ring-opened polyester copolymer of claim 8, wherein the ring-opened polyester copolymer has a molecular weight of between 1.0 kDa and 250 kDa.

10. The ring-opened polyester copolymer of claim 8, wherein the ring-opened polyester copolymer has a carboxylic acid endgroup and an alcohol endgroup.

11. The ring-opened polyester copolymer of claim 8, wherein the ring-opened polyester copolymer has an allyl function group and a cyclohexene functional group within a polymer chain.

12. The ring-opened polyester copolymer of claim 8, wherein the ring-opened polyester copolymer is a color having an ultraviolet-visible absorption relative maxima at about 350-500 nm.

13. The ring-opened polyester copolymer of claim 8, wherein the ring-opened polyester copolymer is a color having an ultraviolet-visible absorption relative maxima at about 350-500 nm and a full width at half maximum range of about 20 nm.

14. The ring-opened polyester copolymer of claim 8, wherein the ring-opened polyester copolymer has a glass transition temperature tunable from 0° C. to 250° C.

15. A polyester resin comprising:
a product of a reaction between a cyclohexene anhydride and a glycidol allyl ether;
a multi-arm thiol; and
a photoinitiator.

16. The polyester resin of claim 15, wherein the multi-arm thiol is a 4-arm thiol comprising pentaerythritol tetrakis(3-mercaptopropionate).

17. The polyester resin of claim 15, wherein the photoinitiator is Irgacure 819.

18. The polyester resin of claim 15, wherein the polyester resin is 3D prinatable.

19. A structure formed by a 3D printing of the polyester resin of claim 15.

20. The structure of claim 19, wherein the structure exhibits shape memory behavior.

21. A resin of claim 1, wherein the resin is depolymerizable.
